(19) United States
(12) Patent Application Publication
(10) Pub. No.: US 2009/0295783 A1
(43) Pub. Date: Dec. 3, 2009

(54) IMAGE DISPLAY APPARATUS AND METHOD

(75) Inventors: Masahiro Baba, Kanagawa-ken (JP); Ryosuke Nonaka, Kanagawa-ken (JP); Goh Itoh, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/472,474

(22) Filed: May 27, 2009

(30) Foreign Application Priority Data
May 29, 2008 (JP) 2008-140602

(51) Int. Cl. G06F 3/038; G09G 3/36

(52) U.S. Cl. 345/213; 345/102

(57) ABSTRACT

A light source emits a light having a luminance. A light source luminance decision unit determines the luminance for a frame of the image based on pixel values of the frame. A conversion unit converts each pixel value of the frame in correspondence with the luminance. A light modulation unit displays the image by modulating a transmittance or a reflectance of the light based on each converted pixel value of the frame. A selection unit selects a timing to change the luminance in a display period of the frame by comparing the luminance for the frame with a luminance for a previous frame. A control unit changes the luminance of the light source to the luminance for the frame at the timing.

### CROSS-REFERENCE TO RELATED APPLICATIONS

This application is based upon and claims the benefit of priority from Japanese Patent Application No. 2008-140602, filed on May 29, 2008; the entire contents of which are incorporated herein by reference.

### FIELD OF THE INVENTION

The present invention relates to an image display apparatus and a method for raising visual contrast of a display video with reduction of a power consumption.

### BACKGROUND OF THE INVENTION

Recently, an image display apparatus such as a liquid crystal display apparatus is widely spread. The image display apparatus prepares a light source and a light modulator to modulate a light intensity (luminance) from the light source. As to this image display apparatus, the light modulator does not have ideal modulation characteristic, and visual contrast occurred by alight leakage from the light modulator drops on the display. Furthermore, even if a gradation value (pixel value) of a display image is low on the whole, the light source is always lightening with the same light intensity (the same luminance). As a result, the power consumption becomes large.

Accordingly, based on an input video, a plurality of improvement methods is proposed, i.e., luminance modulation of a light from the light source and gradation conversion (gamma-conversion) of each pixel of the input video are executed altogether. As one of the plurality of improvement methods, a timing when the image signal is written into a half part of the liquid crystal panel by line-sequential is synthesized with a timing when the light intensity of the light source is changed by frame-sequential (For example, JP-A 2004-287420 (KOKAI)).

However, as to the above-mentioned method, irrespective of the input video, the light intensity of the light source is changed at a fixed timing. Accordingly, the light intensity cannot be dynamically controlled based on the input video. As a result, the visual contrast is not largely improved, and the power consumption is not largely reduced. Furthermore, at a timing when the light intensity of the light source changes suddenly, a flicker occurs on the display image.

### SUMMARY OF THE INVENTION

The present invention is directed to an image display apparatus and a method for suppressing the flicker on the display image by controlling the timing to change the light intensity of the light source.

According to an aspect of the present invention, there is provided an apparatus for displaying an image, comprising: a light source configured to emit a light having a luminance; a light source luminance decision unit configured to determine the luminance for a frame of the image, based on pixel values of the frame; a conversion unit configured to convert each pixel value of the frame in correspondence with the luminance; a light modulation unit configured to modulate a transmittance or a reflectance of the light based on each converted pixel value of the frame to display the image; a selection unit configured to select a timing to change the luminance in a display period of the frame by comparing the luminance for the frame with a luminance for a previous frame; and a control unit configured to change the luminance of the light source to the luminance for the frame at the timing.

According to an aspect of the present invention, there is provided an apparatus for displaying an image, comprising: a plurality of light sources configured to respectively emit a light having a luminance, each light source being set in correspondence with each region on a frame of the image; a light source luminance decision unit configured to determine the luminance of a light source, based on pixel values of a region corresponding to the light source; a conversion unit configured to convert each pixel value of the region in correspondence with the luminance of the light source; a light modulation unit configured to modulate a transmittance or a reflectance of the light from the light source, based on each converted pixel value of the region; a selection unit configured to select a timing to change the luminance in a display period of the region by comparing the luminance for the region with a luminance for a corresponding region on a previous frame; and a control unit configured to change the luminance of the light source to the luminance for the region at the timing.

According to an aspect of the present invention, there is provided method for displaying an image, comprising: determining a luminance of a light source based on pixel values of a frame of the image; converting each pixel value of the frame in correspondence with the luminance; modulating a transmittance or a reflectance of a light from the light source, based on each converted pixel value of the frame; selecting a timing to change the luminance in a display period of the frame by comparing the luminance for the frame with a luminance for a previous frame; and changing the luminance of the light source to the luminance for the frame at the timing.

### BRIEF DESCRIPTION OF THE DRAWINGS

FIG. 1 is a block diagram of an image display apparatus according to a first embodiment.

FIG. 2 is a block diagram of a light source control unit of the image display apparatus in FIG. 1.

FIG. 3 is a timing chart of a light source control signal generated by the image display apparatus according to the first embodiment.

FIG. 4 is another timing chart of a light source control signal generated by the image display apparatus according to the first embodiment.

FIG. 5 is schematic diagrams of an input image and a light source luminance of the input image.

FIG. 6 is time charts of a display luminance in case of changing a light source luminance at a write timing of a first line of a second frame of FIG. 5 onto a liquid crystal panel.

FIG. 7 is schematic diagrams of the display luminance and the light source luminance in case of FIG. 6.

FIG. 8 is time charts of a display luminance in case of changing a light source luminance at a write timing of a last line of a second frame of FIG. 5 onto a liquid crystal panel.

FIG. 9 is schematic diagrams of the display luminance and the light source luminance in case of FIG. 8.

FIG. 10 is schematic diagrams of an input image and a light source luminance of the input image.

FIG. 11 is time charts of a display luminance in case of changing a light source luminance at a write timing of a first line of a second frame of FIG. 10 onto a liquid crystal panel.

FIG. 12 is schematic diagrams of the display luminance and the light source luminance in case of FIG. 11.

FIG. 13 is time charts of a display luminance in case of changing a light source luminance at a write timing of a last line of a second frame of FIG. 10 onto a liquid crystal panel.

FIG. 14 is schematic diagrams of the display luminance and the light source luminance in case of FIG. 13.

FIG. 15 is a block diagram of a light source control unit of the image display apparatus according to a second embodiment.

FIG. 16 is a timing chart of a light source control signal generated by the image display apparatus according to the second embodiment.

FIG. 17 is another timing chart of a light source control signal generated by the image display apparatus according to the second embodiment.

FIG. 18 is another block diagram of a light source control unit of the image display apparatus according to a second embodiment.

FIG. 19 is a block diagram of an image display apparatus according to a third embodiment.

FIG. 20 is a block diagram of a light source control unit of the image display apparatus in FIG. 19.

FIG. 21 is a timing chart of a light source control signal generated by the image display apparatus according to the third embodiment.

FIG. 22 is another timing chart of a light source control signal generated by the image display apparatus according to the third embodiment.

FIG. 23 is a block diagram of a light source control unit of the image display apparatus according to a fourth embodiment.

FIG. 24 is a timing chart of a light source control signal generated by the image display apparatus according to the fourth embodiment.

FIG. 25 is another timing chart of a light source control signal generated by the image display apparatus according to the fourth embodiment.

FIG. 26 is a block diagram of a light source control unit of the image display apparatus according to a fifth embodiment.

FIG. 27 is a timing chart of a light source control signal generated by the image display apparatus according to the fifth embodiment.

FIG. 28 is a timing chart of a light source control signal generated by the image display apparatus according to the fifth embodiment.

FIG. 29 is a block diagram of an image display apparatus according to a sixth embodiment.

FIG. 30 is a schematic diagram of a backlight of the image display apparatus according to the sixth embodiment.

FIG. 31 is a graph of a luminance distribution of one light source in case of the one light source lightening.

FIG. 32 is a graph of a luminance distribution of a backlight in case of a plurality of light sources of the backlight lightening.

FIG. 33 is a block diagram of a luminance distribution calculation unit of the image display apparatus in FIG. 29.

FIG. 34 is one example of the backlight having a plurality of light sources.

FIG. 35 is a timing chart of a light source control signal generated by the image display apparatus according to the sixth embodiment.

FIG. 36 is another timing chart of a light source control signal generated by the image display apparatus according to the sixth embodiment.

### DETAILED DESCRIPTION OF THE EMBODIMENTS

Hereinafter, embodiments of the present invention will be explained by referring to the drawings. The present invention is not limited to the following embodiments.

### The First Embodiment

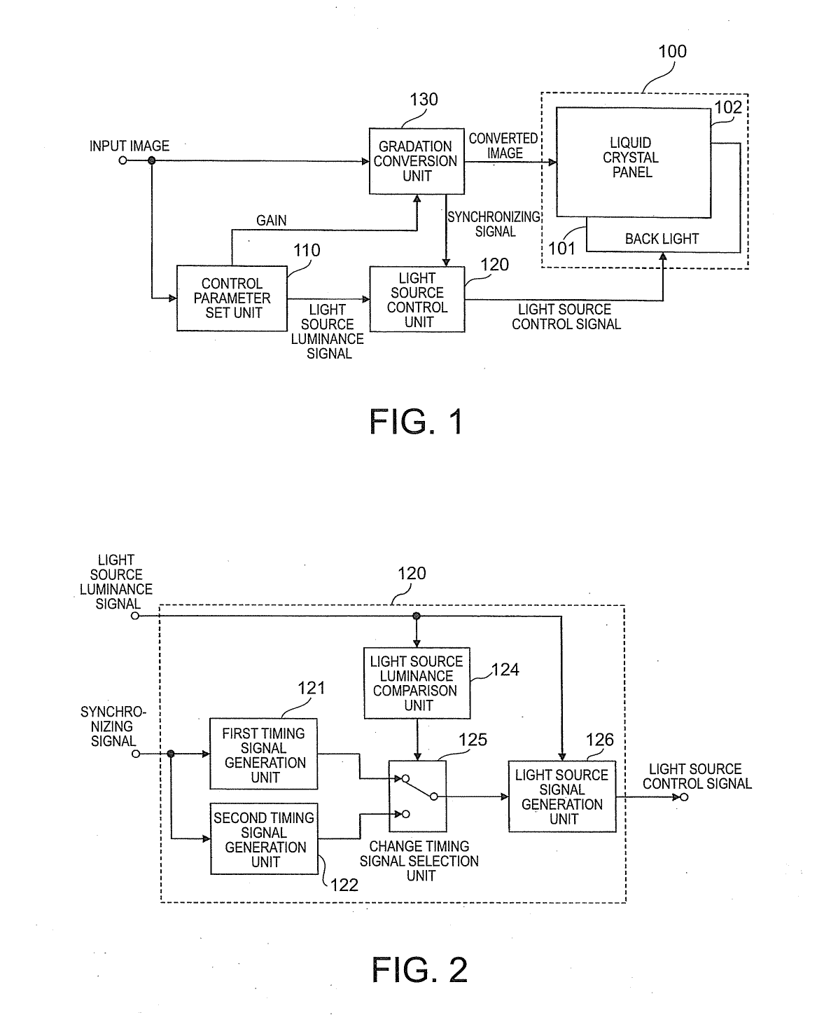

The image display apparatus includes an image display unit 100, a control parameter set unit 110, a light source control unit 120, and a gradation conversion unit 130 shown in FIG. 1.

The image display unit 100 is a liquid crystal display device having a backlight 101 and a liquid crystal panel 102. The backlight 101 as a light source is located at the back of the liquid crystal panel 102. On the liquid crystal panel 102, modulators to modulate a light from the backlight 101 based on a display image are aligned. The display image is a converted image having pixel values (of an image signal) converted by the gradation conversion unit 130.

Each frame of the image signal is input to the control parameter set unit 110 and the gradation conversion unit 130. The control parameter set unit 110 outputs a light source luminance signal and a gain based on a gradation value of each frame of the image signal. The light source luminance signal represents a light intensity (luminance) from the backlight 101. The gain is used to convert the gradation value of each pixel of the input image. The light source luminance signal is input to the light source control unit 120, and the gain is input to the gradation conversion unit 130.

The gradation conversion unit 130 converts a gradation value (pixel value) of each pixel of the input image based on the gain, and outputs a converted image as the display image to the image display unit 100. Furthermore, the gradation conversion unit 130 outputs a synchronizing signal to the light source control unit 120. The synchronizing signal represents a first line of a frame synchronized with an output timing of the converted image (corresponding to a start timing to write the converted image onto the liquid crystal panel 102). For example, this synchronizing signal is a vertical synchronizing signal. The light source control unit 120 outputs a light source control signal (to control a light source luminance of the backlight 101) based on the light source luminance signal to the backlight 101 at a timing of the synchronizing signal. The image display unit 100 writes the converted image into the liquid crystal panel 102. At the same time, the image display unit 100 lightens the backlight 101 based on the light source control signal to display the image. Next, detail processing of each unit is explained.

(The Control Parameter Set Unit 110)

The control parameter set unit 110 calculates a light source luminance to set the backlight 101 and a gain for the gradation conversion unit 130 to convert the input image. First, the control parameter set unit 110 detects a maximum gradation Lₘₐₓ from pixel values of one frame of the input image signal. Next, by converting the maximum gradation Lₘₐₓ to a luminance, the control parameter set unit 110 calculates a maximum luminance lₘₐₓ in the one frame using an equation (1).

$${l}_{max} = {( \frac{{L}_{max}}{255} )}^{γ} \qquad ( 1 )$$

In the equation (1), “γ” is a gamma-value of the liquid crystal panel 102. As to a standard display apparatus, “γ” is 2.2. The luminance is represented as a relative value within “0˜1”.

One example that gradation of pixel value is represented as eight bits (0˜255 gradation) is explained. In case that a maximum gradation in pixel values of one frame is 202 gradation, a maximum luminance is approximately calculated as 0.6 by using the equation (1). Briefly, the image display unit 100 need not display with a luminance higher than 0.6. Accordingly, a light source luminance is set as 0.6. On the other hand, as to an input image to be displayed on the liquid crystal panel 102, a gain to compensate drop of the light source luminance need be given to the input image. The gain G to be given to the input image is calculated by an equation (2).

$$G = \frac{1}{{l}_{max}} \qquad ( 2 )$$

In case of setting the light source luminance as 0.6, pixel values of the input image need be converted in order for the image display unit 100 to display the input image having original pixel values in case of setting the light source luminance as 1.0 (in case that the input image is written onto the liquid crystal panel 102 as it is). In case of the light source luminance “0.6”, the gain to be given to the input image is approximately calculated as 1.7 by using the equation (2). The control parameter set unit 110 outputs the gain to the gradation conversion unit 130. Briefly, the control parameter set unit 110 outputs the light source luminance and the gain (calculated by above-mentioned processing) as a light source luminance signal and a gain respectively.

In the present embodiment, the light source luminance and the gain are calculated by using the equations (1) and (2). However, by previously determining a relationship among the maximum gradation of the input image, the light source luminance and the gain, the relationship may be stored in Read Only Memory (ROM) as a look up table (LUT). In this case, by referring to LUT, the light source luminance and the gain corresponding to the maximum gradation of pixel values of the input image can be selected.

(The Gradation Conversion Unit 130)

The gradation conversion unit 130 converts each pixel value of the input image based on the gain, and outputs a converted image to the liquid crystal panel 102. Each pixel value of the input image is converted by using an equation (3).

Lₒᵤₜ(x,y)=G^{1/γ}·Lin(x,y) (3)

In the equation (3), G is a gain calculated by the equation (2). Lᵢₙ(x,y) represents a gradation (pixel value) of a pixel at a horizontal position x and a vertical position y of the input image. Lₒᵤₜ(x,y) represents a gradation (pixel value) of a pixel at a horizontal position x and a vertical position y of the converted image.

As mentioned-above, in case of the light source luminance “0.6”, pixel values (Lₒᵤₜ(x,y)=(1/0.6)^{1/2.2}×Lin(x,y)) converted by the equation (3) is output. For example, a maximum gradation 202 in pixels of the input image is converted to a gradation 255 by the equation (3). Briefly, the gain G is calculated by the equation (2) to raise a transmittance of light from the backlight 101, and the input image is converted by using the gain G. By writing a converted image onto the liquid crystal panel 102, drop of the light source luminance is compensated. The converted image and control signals (a horizontal synchronizing signal and a vertical synchronizing signal to drive the liquid crystal panel 102) are output to the liquid crystal panel 102.

(The Light Source Control Unit 120)

The light source control unit 120 generates a light source control signal to control a luminance of the backlight 101. Hereinafter, a method for generating the light source control signal is explained in detail by referring to FIGS. 2˜4.

FIG. 2 is a block diagram of the light source control unit 120. The light source control unit 120 includes a first timing signal generation unit 121, a second timing signal generation unit 122, a light source luminance comparison unit 124, a change timing signal selection unit 125, and a light source signal generation unit 126.

A synchronizing signal from the gradation conversion unit 130 is input to the first timing signal generation unit 121 and the second timing signal generation unit 122. In response to the synchronizing signal, the first timing signal generation unit 121 generates a first timing signal and the second timing signal generation unit 121 generates a second timing signal. A period between the synchronizing signal and the first timing signal is a first period and a period between the synchronizing signal and the second timing signal is a second period. The first period is shorter than the second period. If a light source luminance calculated by a present frame downwardly changes from a light source luminance calculated by a previous frame, the light source luminance is changed at timing in synchronization with the first timing signal. If the light source luminance calculated by the present frame upwardly changes from the light source luminance calculated by the previous frame, the light source luminance is changed at timing in synchronization with the second timing signal.

A light source luminance signal set by the control parameter set unit 110 is input to the light source luminance comparison unit 124 and the light source signal generation unit 126. The light source luminance comparison unit 124 compares a light source luminance for the present frame with a light source luminance for the previous frame, and outputs a selection signal based on a comparison result to the change timing signal selection unit 125.

The change timing signal selection unit 125 selects any of the first timing signal and the second timing signal based on the selection signal, and outputs a selected timing signal as a change timing signal to the light source signal generation unit 126. If a light source luminance for a present frame is higher (brighter) than a light source luminance for a previous frame, the second timing signal is selected as the change timing signal. If the light source luminance for the present frame is lower (darker) than the light source luminance for the previous frame, the first timing signal is selected as the change timing signal. Based on the change timing signal and the light source luminance signal, the light source signal generation unit 126 generates a light source control signal and outputs it to the backlight 101.

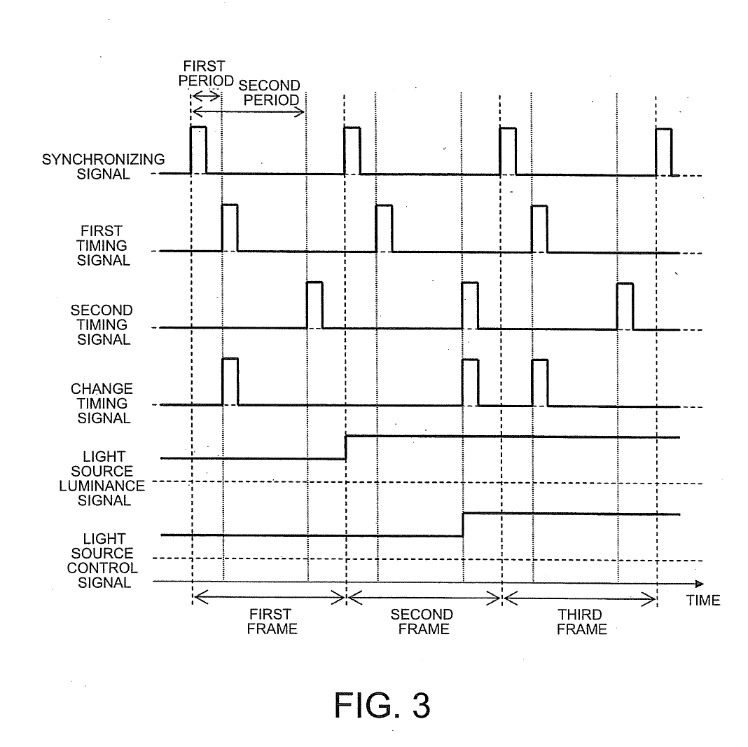

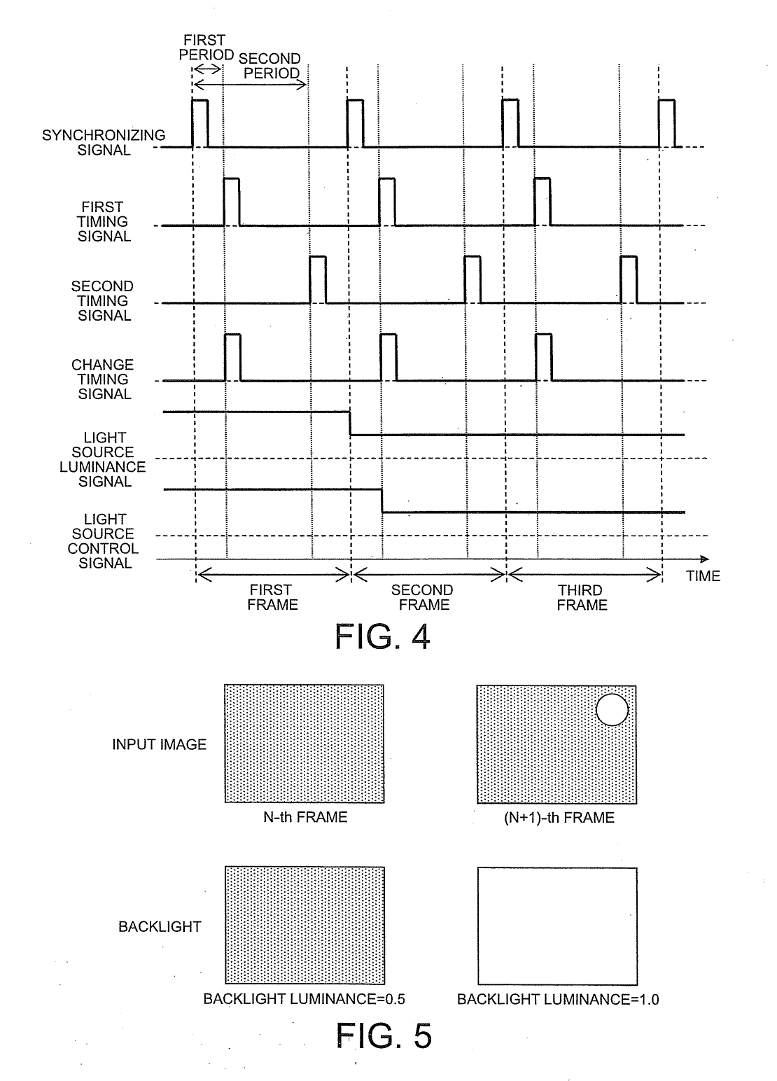

FIGS. 3 and 4 are time charts of timing for the image display unit 100 to change the light source luminance. In FIGS. 3 and 4, a horizontal axis represents time, and a vertical axis represents whether a signal exists (1 or 0) as to the synchronizing signal and three timing signals. As to the light source luminance signal and the light source control signal, the vertical axis represents a light source luminance within “0˜1”.

The change timing signal is any of the first timing signal and the second timing signal selected based on a comparison result of the light source luminance comparison unit 124. In case of inputting a light source luminance signal to change a light source luminance, the light source luminance is changed at timing of the change timing signal. A signal representing temporal change of the light source luminance is generated as a light source control signal, and the backlight 101 is controlled by the light source control signal.

FIG. 3 shows a light source control signal (generated by the light source control unit 120) when the light source control signal to heighten the light source luminance is input between a first frame and a second frame. As shown in FIG. 3, a synchronizing signal represents a start timing to write a converted image onto the liquid crystal panel 102, which has a signal level “1” every one frame period.

The first timing signal is generated from the first timing signal generation unit 121. A signal level of the first timing signal becomes “1” when a first (predetermined) period has passed from the synchronizing signal. The second timing signal is generated from the second timing signal generation unit 122.

A signal level of the second timing signal becomes “1” when a second period (longer than the first period) has passed from the synchronizing signal.

A signal level of the change timing signal becomes “1” at timing to finally change the light source luminance. Based on a comparison result of the light source luminance comparison unit 124, the change timing signal selection unit 125 selects any of the first timing signal and the second timing signal as the change timing signal.

In FIG. 3, as to the first and third frames, the first timing signal is selected as the change timing signal. As to the second frame, the second timing signal is selected as the change timing signal. The light source luminance signal represents a light source luminance set by the control parameter set unit 110, which is an analog signal having “0.5” at the first frame and “1” at the second and third frames. This analog signal is one example. By supposing a digital signal processing LSI, the light source luminance signal becomes a digital signal.

A light source control signal is generated based on the light source luminance signal, which controls the backlight to change a light source luminance at timing of the change timing signal. In other words, the light source control signal is a signal to drive the backlight as a light source. In FIG. 3, the light source control signal is an analog signal in same way as the light source luminance signal. However, the light source control signal may be a signal to control the light source luminance, such as PWM (Pulse Width Modulation) signal.

Next, as the change timing signal, a method for selecting any of the first timing signal and the second timing signal is explained. In FIG. 3, the light source luminance signal changes at start timing of the second frame. The light source luminance comparison unit 124 stores a light source luminance signal of a previous frame, and compares the light source luminance of the previous frame with a light source luminance of a present frame when a light source luminance signal of the present frame is input. If the light source luminance of the previous frame is lower than the light source luminance of the present frame, the second timing signal is selected as the change timing signal. In another case, the first timing signal is selected as the change timing signal. In FIG. 3, the light source luminance of the first frame (previous frame) is lower than the light source luminance of the second frame (present frame). Accordingly, the second timing signal is selected as the change timing signal.

As to the light source control signal, a light source changes at timing when a level of the change timing signal becomes “1”. The light source control signal is input to the backlight 101. A first period and a second period are desirably set in consideration with a response time of a liquid crystal. Briefly, the first period is set as 0˜10% of the response time of the liquid crystal, and the second period is set as 0˜90% of the response time of the liquid crystal. By above-mentioned setting, the first period is shorter than the response time of the liquid crystal, and the second period is longer than the response time of the liquid crystal.

FIG. 4 shows a light source control signal (generated by the light source control unit 120) when the light source control signal to lower the light source luminance is input between a first frame and a second frame. As shown in FIG. 4, when the light source luminance drops from “1” of the first frame to “0.5” of the second frame, the light source luminance of the first frame (previous frame) is higher than the light source luminance of the second frame (present frame). Accordingly, as the change timing signal, the first timing signal is selected.

In the first embodiment, when a light source luminance does not change between the previous frame and the present frame, the first timing signal is selected as the change timing signal. However, when the light source luminance does not change, the change timing signal selected at the previous frame may be maintained. In this case, as the change timing signal of the third frame in FIG. 3, the second timing signal selected at the second frame is selected.

(The Image Display Unit 100)

The image display unit 100 includes a liquid crystal panel 102 (a light modulator) and a backlight 101 (a light source) set at the back of the liquid crystal panel 102. In general, a cold cathode fluorescence lamp or a light emitting diode (LED) is used as the light source of the backlight 101. In the first embodiment, an LED light source having a luminance easily controlled is used as the backlight 101, and the luminance of the LED light source is modulated by control of pulse width modulation (PWM). Accordingly, the light source control signal as a PWM signal based on the light source luminance is input to the backlight 101. The image display unit 100 writes a converted image (converted by the gradation conversion unit 130) onto the liquid crystal panel 102. Furthermore, by lighting the backlight 101 based on the light source control signal, an image is displayed on the image display unit 100.

The upper part of FIG. 5 shows the input image to be displayed, and the lower part of FIG. 5 shows the light source luminance set by the control parameter set unit. As shown in FIG. 5, the input image of the N-th frame has 186 gradation on an entire screen. The input image of the (N+1)-th frame has an object of 255 gradation on a partial screen. By the equation (1), a light source luminance of the N-th frame is set as “0.5” and a light source luminance of the (N+1)-th frame is set as “1.0”.

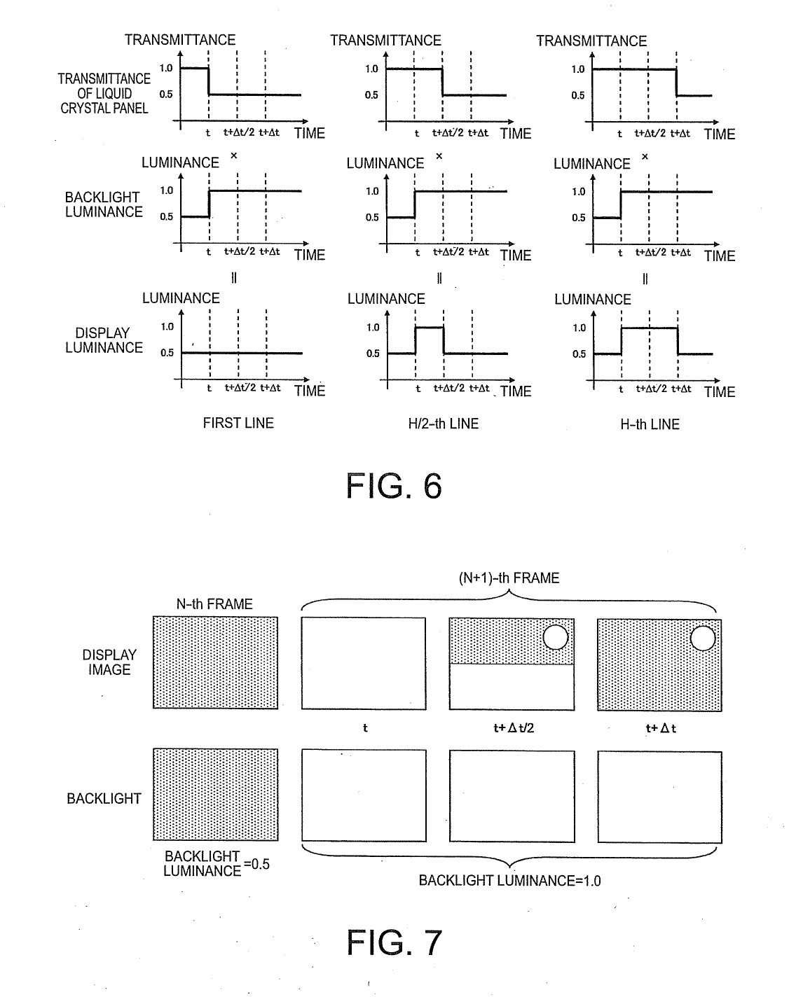

Hereinafter, in case of inputting the image shown in FIG. 5, relationship between display images from the N-th frame to the (N+1) -frame and change timing of the light source luminance is explained by referring to FIGS. 6˜9. In order to simplify the explanation, a response speed of the liquid crystal panel 102 is set as “0”. Briefly, after the image is written onto the liquid crystal panel, the image is immediately displayed.

FIG. 6 is temporal change of a display luminance on the image display unit 100 if a light source luminance of the backlight 101 is changed at a timing when the first line of the converted image is written onto the liquid crystal panel 102. In FIG. 6, the upper part shows a temporal change of a transmittance of the liquid crystal panel 102, the middle part shows a temporal change of a light source luminance of the backlight 101, and the lower part shows a temporal change of a display luminance on the image display unit 100 by transmitting a light from the backlight 101 through the liquid crystal panel 102.

Furthermore, the left lower part shows the display luminance when the first line of the converted image is written onto the liquid crystal panel 102, the middle lower part shows the display luminance when the H/2-th line (half line) of the converted image is written onto the liquid crystal panel 102, and the right lower part shows a display luminance when the H-th line (last line) of the converted image is written onto the liquid crystal panel 102. A timing to write the first line of the converted image is t, a timing to write the half line of the converted image is t+Δt/2, and a timing to write the last line of the converted image is t+Δt.

In FIG. 6, a horizontal axis represents a time, and a vertical axis represents a transmittance of liquid crystal panel, a backlight luminance, and a display luminance from the upper part in order. The transmittance of the liquid crystal panel 101 is determined based on a luminance of the converted image. The converted image changes from the N-th frame to the (N+1) -th frame at a timing “t”, and one frame period is represented as “Δt”. Furthermore, the number of lines of the liquid crystal panel 102 along a vertical direction is “H”.

The light source luminance changes from 0.5 of the N-th frame to 1.0 of the (N+1)-th frame at a timing t when the first line of the converted image is written onto liquid crystal panel 102. On the other hand, the converted image (to be written onto the liquid crystal panel 102) changes from the N-th frame having a gain 2.0 to the (N+1)-th frame having a gain 1.0, based on change of the light source luminance. At a timing t, the first line of the (N+1)-th frame is written. At a timing t+Δt/2, the H/2-th line of the (N+1)-th frame is written. At a timing t+Δt, the H-th line of the (N+1) -th frame is written. At the first line, change of transmittance of the liquid crystal panel 102 synchronizes with change of the light source luminance. Accordingly, as shown in the left lower part of FIG. 6, a display luminance having 186 gradation does not change.

On the other hand, at the H/2-th line, change timing of transmittance of the liquid crystal panel 102 is t+Δt/2. In comparison with a light source luminance changed at a timing t, the transmittance changes at a timing delayed as Δt/2. As a result, as shown in the middle lower part of FIG. 6, the image having 186 gradation is displayed by a display luminance 1.0 during a period between t and t+Δt/2. In the same way, at the H-th line, the transmittance of the liquid crystal panel 102 changes at a timing delayed as Δt. As a result, as shown in the right lower part of FIG. 6, the image having 186 gradation is displayed by a display luminance 1.0 during a period between t and t+Δt.

FIG. 7 shows display images on the image display unit 100 from timing t to timing t+Δt in case of changing the light source luminance at the timing of FIG. 6. As to the N-th frame, a backlight luminance (light source luminance) drops to 0.5, the image is converted from 186 gradation to 255 gradation, and the transmittance of the liquid crystal panel becomes 1.0. As a result, the image having a display luminance 0.5 is displayed.

Next, in case of changing the light source luminance (backlight luminance) from 0.5 to 1.0 at a timing to write the first line of a converted image, the converted image written in the liquid crystal panel 102 is still the N-th frame having 255 gradation. As to the transmittance 1.0 of the liquid crystal panel 102, the light source luminance becomes 1.0. As a result, as shown in FIG. 7, the image is displayed by the display luminance 1.0.

In the same way, at a timing t+Δt/2 to write the H/2-th line of the converted image, the converted image from the H/2-th line to the H-th line (written in the liquid crystal panel 102) has 255 gradation of the N-th frame, which is displayed by the display luminance 1.0. As a result, an image having 186 gradation to be displayed by the display luminance 0.5 is displayed by the display luminance 1.0, and the observer views a flicker on the displayed image.

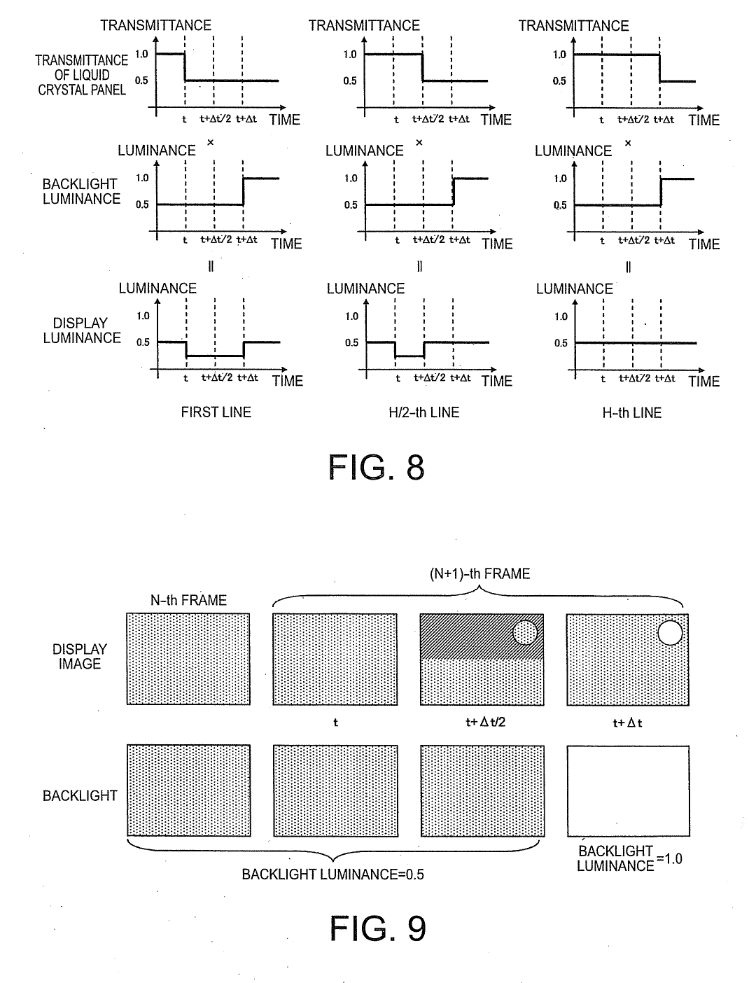

FIG. 8 shows temporal change of a display luminance on the image display unit 100 if a light source luminance of the backlight 101 is changed at a timing when the last line of the converted image is written onto the liquid crystal panel 102. In comparison with FIG. 6, the timing to change the light source luminance is changed from t to t+Δt in FIG. 8. In the same way as FIG. 6, at the first line, an image having 186 gradation to be displayed by the display luminance 0.5 is displayed by the display luminance 0.25 during a period between t and t+Δt. Furthermore, at the H/2-th line, the image having 186 gradation to be displayed by the display luminance 0.5 is displayed by the display luminance 0.25 during a period between t and t+Δt/2.

FIG. 9 shows display images on the image display unit 100 from timing t to timing t+Δt in case of changing a backlight luminance at the timing t+Δt of FIG. 8. As to the N-th frame, the backlight luminance (light source luminance) drops to 0.5, the image is converted from 186 gradation to 255 gradation, and the transmittance of the liquid crystal panel becomes 1.0. As a result, the image is displayed by the display luminance 0.5.

Next, at a timing to write the first line of a converted image, the converted image written in the liquid crystal panel 102 is still the N-th frame having 255 gradation, and the light source luminance is maintained as 0.5 of the N-th frame. As a result, the image is displayed by the display luminance 0.5.

Next, at a timing t+Δt/2 to write the H/2-th line of the converted image, the (N+1)-th frame (corresponding to the light source luminance 1.0) from the first line to the H/2-th line is written onto the liquid crystal panel 102. On the other hand, the light source luminance is maintained as 0.5. As a result, as shown in FIG. 9, an image having 186 gradation to be displayed by the display luminance 0.5 is displayed by the display luminance 0.25. Then, at a timing t+Δt to write the H-th line of the converted image, the (N+1)-th frame is entirely written to the last line. By setting the light source luminance as 1.0, the (N+1)-th frame is correctly displayed.

As shown in FIGS. 6˜9, at a timing to change a light source luminance, change (flicker) of a display luminance on a display image occurs by a difference between a timing to line-sequentially write a converted image onto the liquid crystal panel 102 and the timing to frame-sequentially change the light source luminance. However, by comparing FIGS. 6˜7 with FIGS. 8˜9, a change ratio of the display luminance is 0.5 in case of changing the light source luminance at a timing to write the first line of the converted image. On the other hand, a change ratio of the display luminance is 0.25 in case of changing the light source luminance at a timing to write the last line of the converted image Briefly, in case of highly changing a light source luminance, by changing the light source luminance at a late timing (the second half) during a period to write the converted image, occurrence of flicker by change of the light source luminance is suppressed.

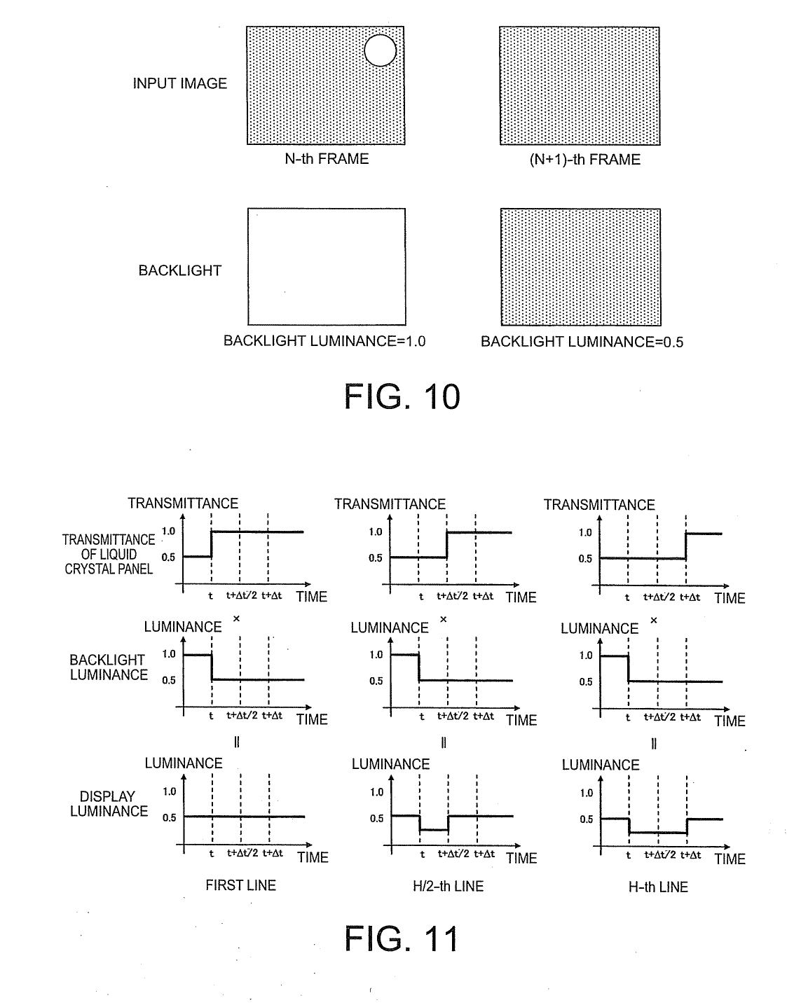

In above-mentioned explanation, the case to highly change the light source luminance from 0.5 to 1.0 was described. Hereinafter, the case to lowly change the light source luminance will be explained. The upper part of FIG. 10 shows the input image to be displayed, and the lower part of FIG. 10 shows the light source luminance set by the control parameter set unit.

As shown in FIG. 10 in the other way as FIG. 5, the input image of the N-th frame has 186 gradation of a background region with 255 gradation of an object region. The input image of the (N+1)-th frame has 255 gradation on an entire screen. By the equation (1), a light source luminance of the N-th frame is set as “1.0” and a light source luminance of the (N+1)-th frame is set as “0.5”. In this case, relationship between display images from the N-th frame to the (N+1) -frame and change timing of the light source luminance is explained hereinafter.

FIG. 11 is temporal change of a display luminance on the image display unit 100 if a light source luminance of the backlight 101 is changed at a timing when the first line of the converted image is written onto the liquid crystal panel 102. The light source luminance changes from 1.0 of the N-th frame to 0.5 of the (N+1)-th frame at a timing t when the first line of the converted image is written onto liquid crystal panel 102. On the other hand, the converted image (to be written onto the liquid crystal panel 102) changes from the N-th frame having a gain 1.0 to the (N+1)-th frame having a gain 2.0, based on change of the light source luminance. At a timing t, the first line of the (N+1)-th frame is written. At a timing t+Δt/2, the H/2-th line of the (N+1)-th frame is written. At a timing t+Δt, the H-th line of the (N+1)-th frame is written. At the first line, change of transmittance of the liquid crystal panel 102 synchronizes with change of the light source luminance. Accordingly, as shown in the left lower part of FIG. 11, a display luminance having 186 gradation does not change.

On the other hand, at the H/2-th line, change timing of transmittance of the liquid crystal panel 102 is t+Δt/2. In comparison with a light source luminance changed at a timing t, the transmittance changes at a timing delayed as Δt/2. As a result, as shown in the middle lower part of FIG. 11, the image having 186 gradation is displayed by a display luminance 0.25 during a period between t and t+Δt/2. In the same way, at the H-th line, the transmittance of the liquid crystal panel 102 changes at a timing delayed as Δt. As a result, as shown in the right lower part of FIG. 11, the image having 186 gradation is displayed by a display luminance 0.25 during a period between t and t+Δt.

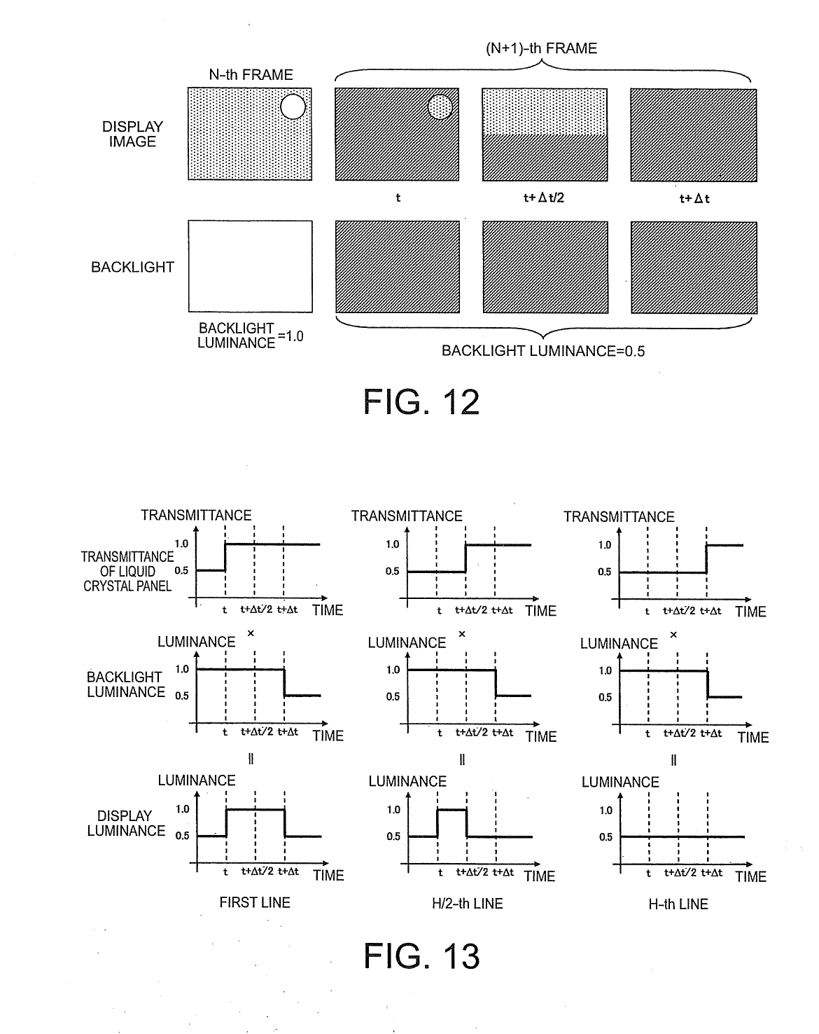

FIG. 12 shows display images on the image display unit 100 from timing t to timing t+Δt in case of changing the light source luminance at the timing of FIG. 11. As to the N-th frame, at pixel positions to display an image having 186 gradation by a light source luminance (backlight luminance) 1.0, a transmittance of the liquid crystal panel is 0.5. Accordingly, the image is displayed by a display luminance 0.5.

Next, in case of changing the light source luminance (backlight luminance) from 1.0 to 0.5 at a timing to write the first line of a converted image, the converted image written in the liquid crystal panel 102 is still the N-th frame having 186 gradation. As to the transmittance 0.5 of the liquid crystal panel 102, the light source luminance becomes 0.5. As a result, as shown in FIG. 12, the image is displayed by the display luminance 0.25.

In the same way, at a timing t+Δt/2 to write the H/2-th line of the converted image, the converted image from the H/2-th line to the H-th line (written in the liquid crystal panel 102) has 186 gradation of the N-th frame, which is displayed by the display luminance 0.25. As a result, an image having 186 gradation to be displayed by the display luminance 0.5 is displayed by the display luminance 0.25.

FIG. 13 shows temporal change of a display luminance on the image display unit 100 if a light source luminance of the backlight 101 is changed at a timing when the last line (the H-th line) of the converted image is written onto the liquid crystal panel 102. In comparison with FIG. 11, the timing to change the light source luminance is changed from t to t+Δt in FIG. 13. In the same way as FIG. 11, at the first line, an image having 186 gradation is displayed by the display luminance 1.0 during a period between t and t+Δt. Furthermore, at the H/2-th line, the image having 186 gradation is displayed by the display luminance 1.0 during a period between t and t+Δt/2.

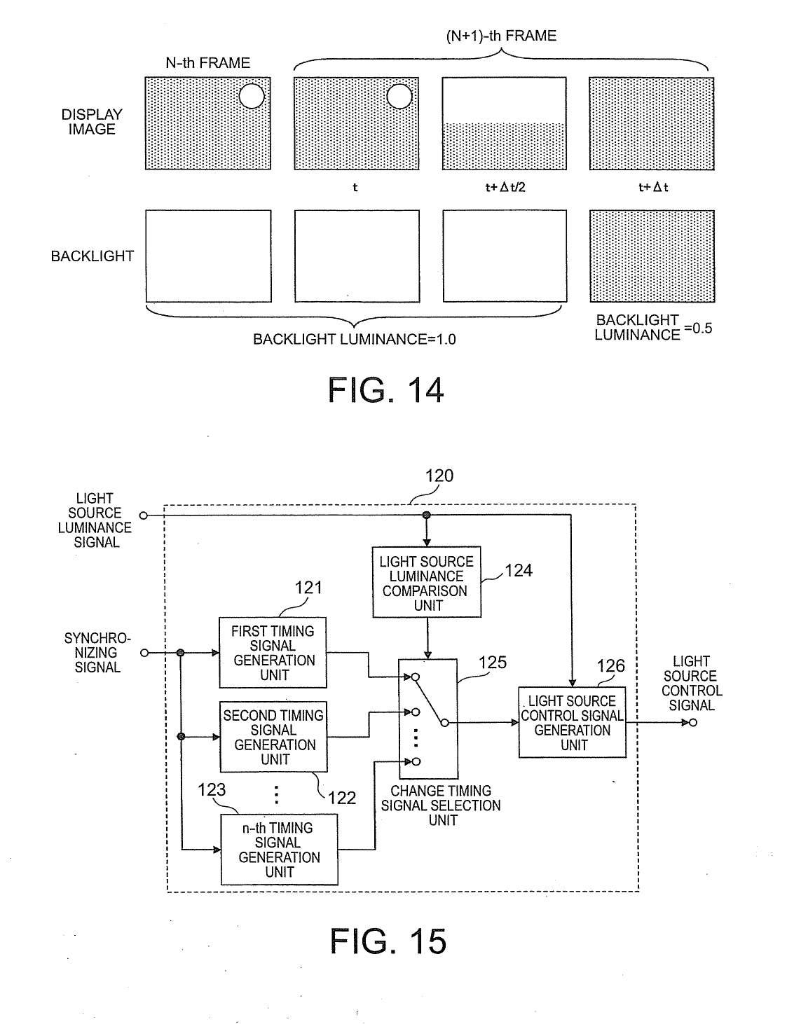

FIG. 14 shows display images on the image display unit 100 from timing t to timing t+Δt in case of changing a backlight luminance at the timing t+Δt of FIG. 13. As to the N-th frame, the backlight luminance (light source luminance) is 1.0, the converted image has 186 gradation, and the transmittance of the liquid crystal panel is 0.5. As a result, the image is displayed by the display luminance 0.5.

Next, at a timing to write the first line of the converted image, the converted image written in the liquid crystal panel 102 is still the N-th frame having 186 gradation, and the light source luminance is maintained as 1.0 of the N-th frame. As a result, the image is displayed by the display luminance 0.5.

Next, at a timing t+Δt/2 to write the H/2-th line of the converted image, the (N+1)-th frame (corresponding to the light source luminance 0.5) from the first line to the H/2-th line is written onto the liquid crystal panel 102. On the other hand, the light source luminance is maintained as 1.0. As a result, as shown in FIG. 14, each pixel value of an image having 186 gradation (from the first line to the H/2-th line) is converted to 255 gradation (transmittance'1.0) by the equation (3), and the image is displayed by the display luminance 1.0. Then, at a timing t+Δt to write the H-th line of the converted image, the (N+1) -th frame is entirely written to the last line. By setting the light source luminance as 0.5, the (N+1)-th frame is correctly displayed.

In the same way as FIGS. 6˜9, as shown in FIGS. 11˜14, at a timing to change a light source luminance, change (flicker) of a display luminance on a display image occurs by a difference between a timing to line-sequentially write the converted image onto the liquid crystal panel 102 and the timing to frame-sequentially change the light source luminance. However, by comparing FIGS. 11˜12 with FIGS. 13˜14, a change ratio of the display luminance is 0.25 in case of changing the light source luminance at a timing to write the first line of the converted image. On the other hand, a change ratio of the display luminance is 0.5 in case of changing the light source luminance at a timing to write the last line of the converted image. Briefly, in case of lowly changing a light source luminance, by changing the light source luminance at an early timing (the first half) during a period to write the converted image, occurrence of flicker by change of the light source luminance is suppressed.

As mentioned-above, when the light source luminance changes from a low value to a high value or from a high value to a low value, by suitably changing a timing to change the light source luminance, the occurrence of flicker by change of the light source luminance is suppressed. Briefly, in the first embodiment, by suppressing the occurrence of flicker, the image display apparatus having an excellent visual contrast is provided with the reduced power consumption.

### The Second Embodiment

As to component of an image display apparatus of the second embodiment, a light source control unit 120 different from the first embodiment is prepared. In the first embodiment, a change timing signal of the light source luminance is selected from two timing signals. In the second embodiment, in order to minutely control the change timing signal, a larger number of timing signals is prepared. Hereinafter, the light source control unit 120 is explained in detail. Other units of the image display apparatus of the second embodiment are same as the first embodiment. Accordingly, the explanation is omitted.

(The Light Source Control Unit 120)

The light source control unit 120 includes timing signal generation units from the first one to the n-th one. In the first embodiment, any of the first timing signal and the second timing signal is selected as a change timing signal of the light source luminance. In the second embodiment, one of timing signals from the first one to the n-th one is selected as the change timing signal, and a light source control signal is generated based on the change timing signal.

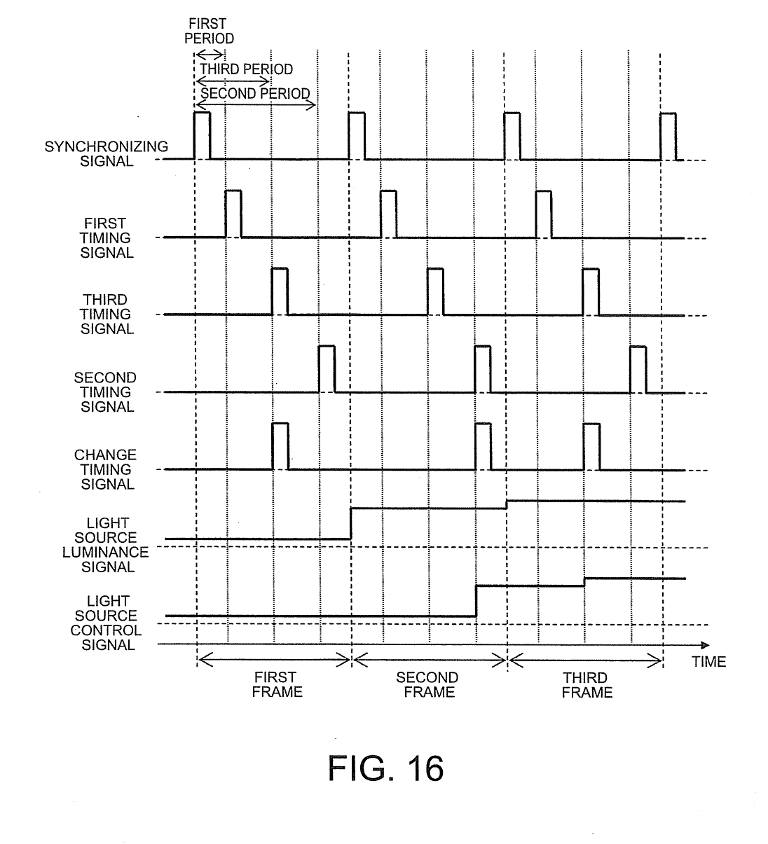

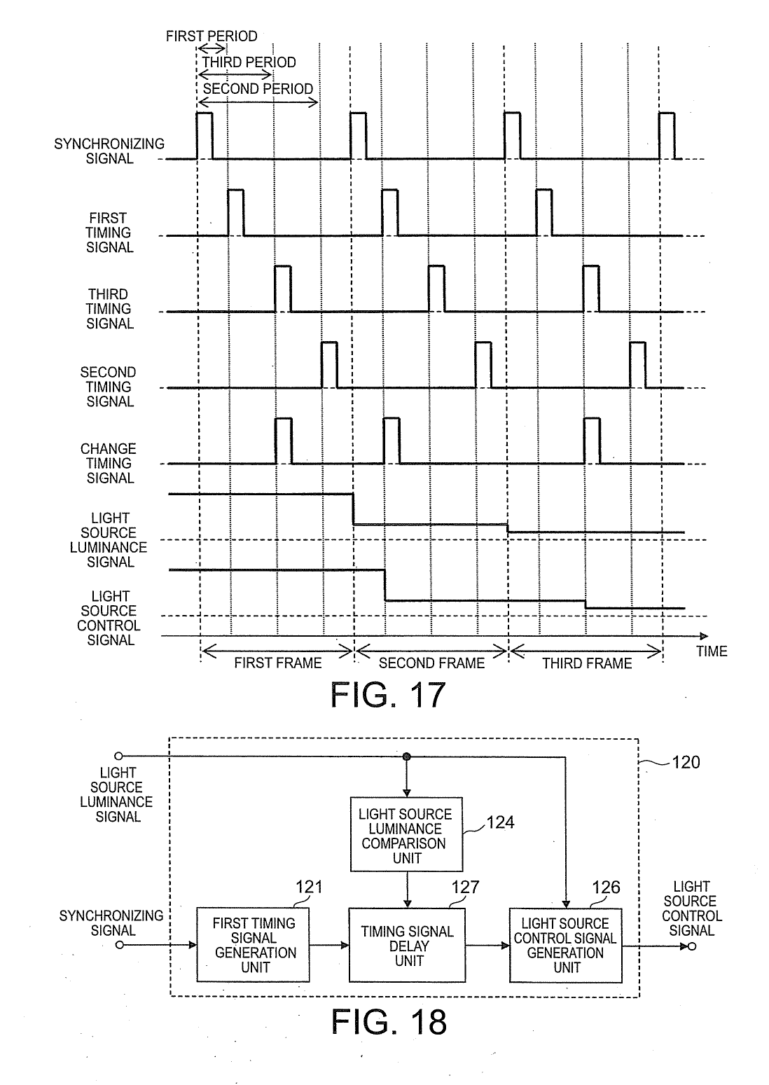

Next, the change timing of the light source control signal is explained by referring to FIGS. 16 and 17. In order to simplify the explanation, three kinds (first, second, third) of timing signals are prepared. Based on a result of the light source luminance comparison unit 124, one timing signal is selected from the three kinds of timing signals, and output as a change timing signal. A third timing signal is generated from the n-th timing signal generation unit 123.

As shown in FIGS. 16 and 17, the three kinds of timing signals are respectively output when a first period (a second period, a third period) has passed from an input timing of a synchronizing signal. In the second embodiment, the third period is set at a center of difference period between the first period and the second period. Based on a selection signal from the light source luminance comparison unit 124, the change timing signal selection unit 125 selects any of the first, second and third timing signals. The light source luminance comparison unit 124 outputs the selection signal by comparing a light source luminance of a previous frame with a light source luminance of a present frame. In the second embodiment, the selection signal is output by an equation (4).

$$selection signal = \{ \begin{matrix}first timing signal I ( n ) - I ( n - 1 ) ≺ - T \\ third timing signal \vert I ( n ) - I ( n - 1 ) \vert \leq T \\ second timing signal I ( n ) - I ( n - 1 ) ≻ T\end{matrix} \qquad ( 4 )$$

In the equation (4), “I(n)” represents a light source luminance of the n-th frame (present frame), and “T” represents a predetermined threshold. By subtracting a light source luminance of a previous frame from a light source luminance of a present frame, if a difference is smaller than −T, the first timing signal is selected. If the difference is larger than T, the second timing signal is selected. If an absolute value of the difference is equal to or smaller than T (if change of the light source luminance is small), the third timing signal is selected.

FIG. 16 shows a light source control signal when a light source luminance signal of the first, second and third frames is input. In this case, a difference of the light source luminance between the first frame and the second frame is larger than a threshold T, and an absolute value of the difference of the light source luminance between the second frame and the third frame is equal to or smaller than the threshold T.

For example, in case of inputting a light source luminance signal shown in FIG. 16, a light source control signal from the first frame to the second frame changes at the second timing, and a light source control signal from the second frame to the third frame changes at the third timing.

FIG. 17 shows a light source control signal when another light source luminance signal of the first, second and third frames is input. In this case, the difference of the light source luminance between the first frame and the second frame is smaller than a threshold −T, and the absolute value of the difference of the light source luminance between the second frame and the third frame is equal to or smaller than the threshold T.

For example, in case of inputting a light source luminance signal shown in FIG. 17, a light source control signal from the first frame to the second frame changes at the first timing, and a light source control signal from the second frame to the third frame changes at the third timing.

Component of the light source control unit 120 of FIG. 15 is one example. For example, following component may be prepared. FIG. 18 is another component of the light source control unit 120 of the second embodiment. In FIG. 18, the light source control unit 120 includes a first timing signal generation unit 121, a light source luminance comparison unit 124, a light source control signal generation unit 126, and a timing signal delay unit 127. In the second embodiment, the first timing signal generation unit 121 only generates a (first) timing signal. Furthermore, the timing signal delay unit 127 is different unit from other embodiments.

Based on a comparison result of the light source luminance comparison unit 124, the timing signal delay unit 127 generates a change timing signal by delaying the first timing signal. If a light source luminance of a present frame changes lowly from a light source luminance of a previous frame, a signal slightly delayed from the first timing signal is set as the change timing signal. Furthermore, if the light source luminance of the present frame changes highly from the light source luminance of the previous frame, a signal largely delayed from the first timing signal is set as the change timing signal. For example, in the latter case, by delaying a second timing signal of the present frame with one frame period, this delayed timing signal may be used as a first timing signal of a next frame. Briefly, by controlling a delay period of the change timing signal based on a comparison result (from the light source luminance comparison unit 124), the light source luminance can be controlled.

As mentioned-above, in the second embodiment, by minutely controlling the change timing of the light source luminance, the occurrence of flicker can be suppressed. As a result, the image display apparatus having an excellent visual contrast is provided with the reduced power consumption.

### The Third Embodiment

As to the third embodiment, in order to suppress excessive change of a timing to change the light source luminance, the image display apparatus prepares a scene change detection unit 140. Based on a change of the light source luminance and a detection result of scene change, the timing to change the light source luminance is controlled.

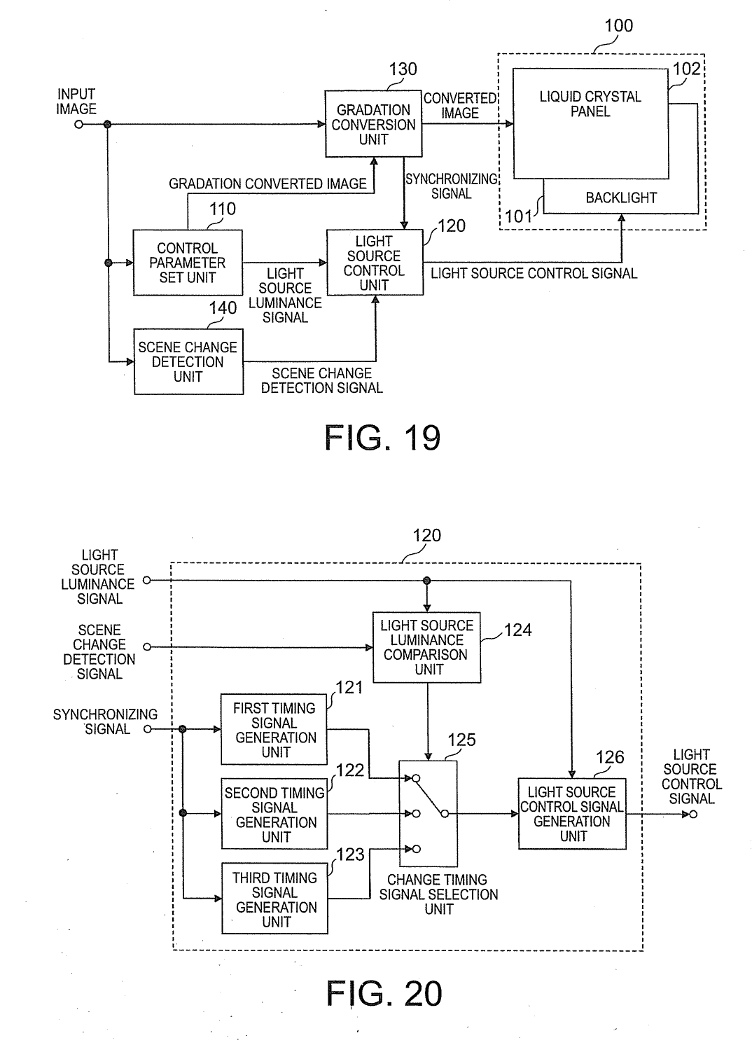

As shown in FIG. 19, the image display apparatus further includes a scene change detection unit 140. The light source control unit 120 inputs a synchronizing signal, a light source luminance signal and a scene change detection signal (detected by the scene change detection unit 140), and generates a light source control signal. Hereinafter, the scene change detection unit 140 and the light source control unit 120 (each different from the first embodiment) are explained in detail. Other units of the third embodiment are same as the first embodiment. Accordingly, the explanation is omitted.

(The Scene Change Detection Unit 140)

A method for detecting a scene change (by the scene change detection unit 140) is variously considered. In the third embodiment, a scene change is detected using a histogram detected from two frames temporally adjacent. A frequency of gradation x of the n-th frame is set as h(x,y). The scene change is detected by an equation (5).

$$s ( n ) = \{ \begin{matrix}1 & {\sum }_{x ≐ 0}^{255} \vert h ( x , n ) - h ( x , n - 1 ) \vert ≻ {T}_{s} \\ 0 & otherwise\end{matrix} \qquad ( 5 )$$

In the equation (5), “s(n)” represents a detection result of a scene change in the n-th frame, “1” represents the scene change, “0” represents non-scene change, and Tₛ represents a threshold to decide the scene change. The detection result of the scene change is input to the light source control unit 120 as a scene change detection signal.

(The Light Source Control Unit 120)

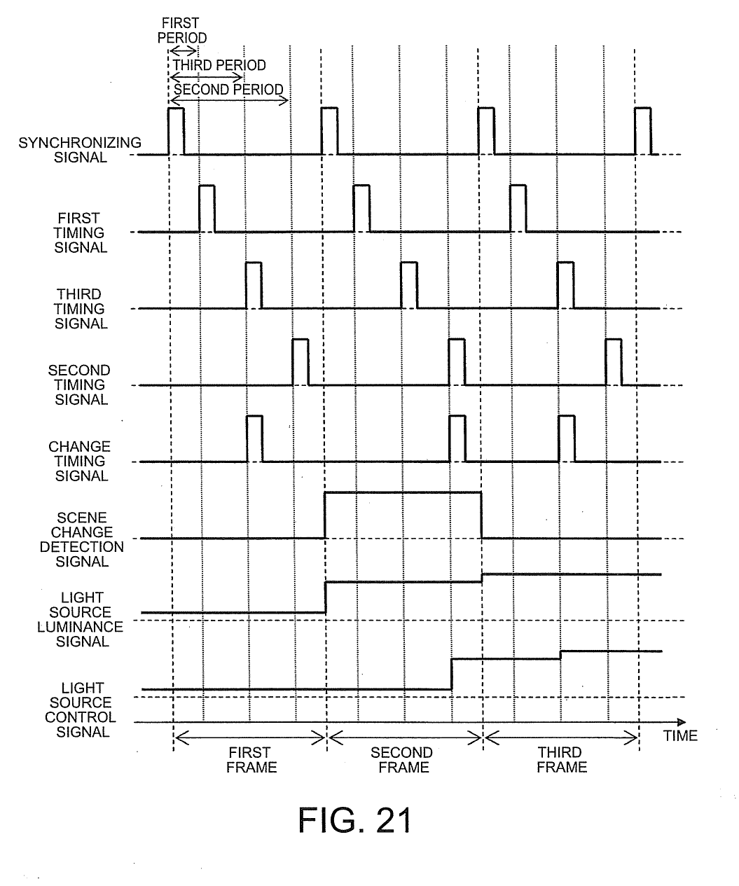

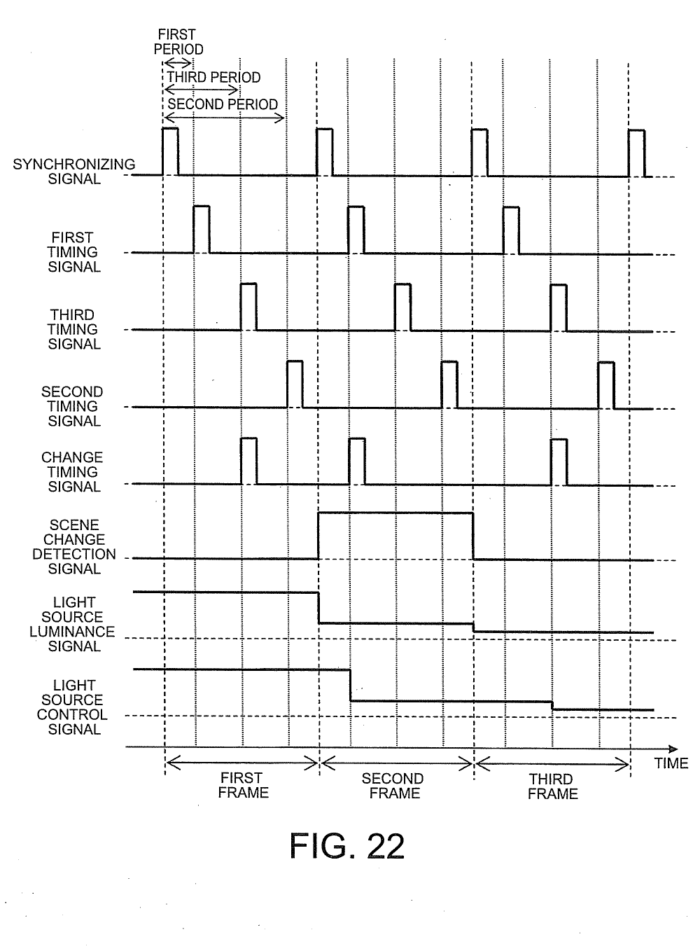

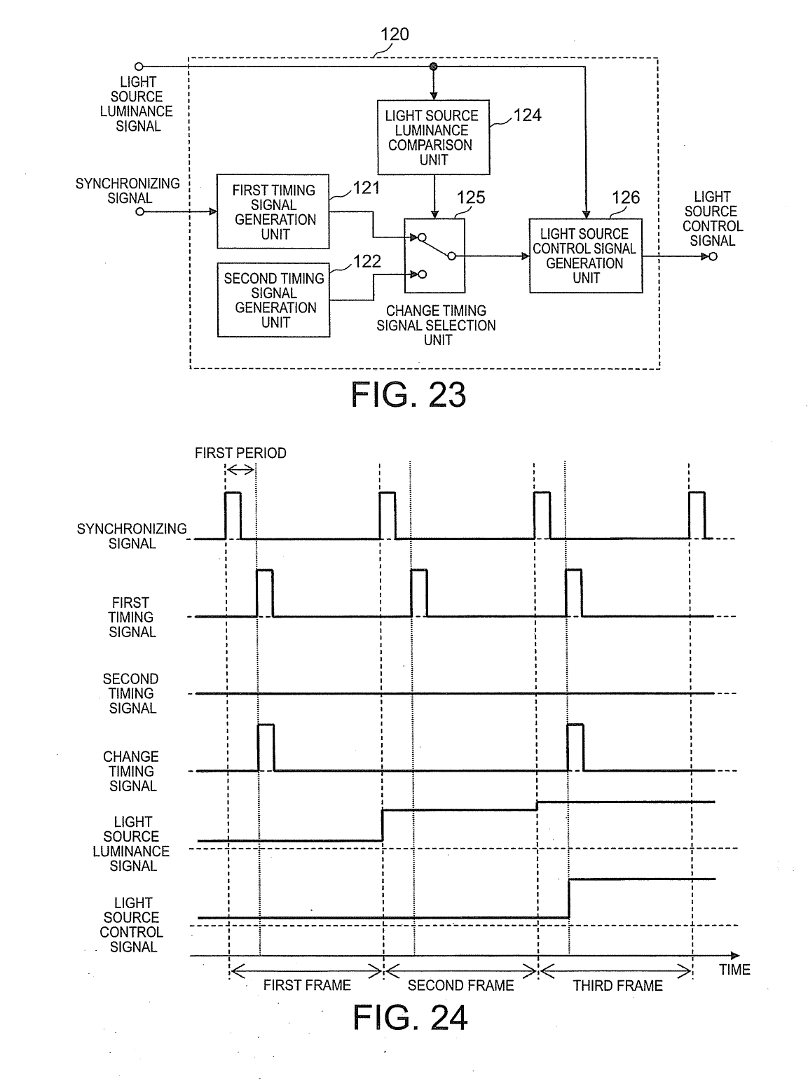

FIG. 20 is a block diagram of the light source control unit 120 of the third embodiment. The light source control unit 120 selects any of the first, second and third timing signals, based on a selection signal from the light source luminance comparison unit 124 using a light source luminance signal and a scene change detection signal. The change timing of a light source control signal is explained by referring to FIGS. 21 and 22. As shown in FIGS. 21 and 22, the first, second and third timing signals are respectively outputted when the first, second and third periods passed from a synchronizing signal. In the third embodiment, the third period is set at a center of a difference period between the first period and the second period. The change timing signal selection unit 125 selects any of the first, second and third signals based on the selection signal from the light source luminance comparison unit 124. By comparing a light source luminance of a previous frame with a light source luminance of a present frame, the light source luminance comparison unit 124 outputs the selection signal based on the scene change detection signal and the comparison result. In the third embodiment, the selection signal is determined by an equation (6).

$$selection signal = \{ \begin{matrix}first timing signal [ s ( n ) = 1 ] ⋀ [ I ( n ) - I ( n - 1 ) ≺ 0 ] \\ third timing signal [ s ( n ) = 0 ] ⋁ [ \vert I ( n ) - I ( n - 1 ) \vert = 0 ] \\ second timing signal [ s ( n ) = 1 ] ⋀ [ I ( n ) - I ( n - 1 ) ≻ 0 ]\end{matrix} \qquad ( 6 )$$

In the equation (6), “s(n)” represents a scene change detection signal of the n-th frame detected by the scene change detection signal, and “I(n)” represents a light source luminance of the n-th frame. In case that s(n)=1 (scene change is detected) and the light source luminance changes lowly, the first timing signal is selected. In case that s(n)=1 (scene change is detected) and the light source luminance changes highly, the second timing signal is selected. In case of s(n)=0 (scene change is not detected) or the light source luminance does not changes, the third timing signal is selected.

For example, as shown in FIG. 21, when the light source luminance changes highly and scene change is detected between the first frame and the second frame, the light source control signal changes at the second timing. On the other hand, when the light source luminance changes highly and scene change is not detected between the second frame and the third frame, the light source control signal changes at the third timing. Furthermore, as shown in FIG. 22, when the light source luminance changes lowly and scene change is detected between the first frame and the second frame, the light source control signal changes at the first timing. On the other hand, when the light source luminance changes lowly and scene change is not detected between the second frame and the third frame, the light source control signal changes at the third timing.

As to the image display apparatus of the third embodiment, in case of scene change having light source luminance changed largely, the light source luminance is controlled at a timing based on change of the light source luminance. Accordingly, a flicker occurred at a scene change by switching the light source luminance can be suppressed.

In the third embodiment, in case of non-scene change, the light source luminance is changed at the third timing when the third period (longer than the first period and shorter than the second period) has passed from the synchronizing signal. However, the light source luminance may be changed at a predetermined timing in a frame. In case of non-scene change, even if the light source luminance is changed, a flicker is hard to occur. Accordingly, in case of scene change only, by changing a light source luminance at a suitable timing for change of the light source luminance, the backlight 101 is effectively controlled.

### The Fourth Embodiment

As to the image display apparatus of the fourth embodiment, component of the light source control unit 120 is different from the first embodiment. In the fourth embodiment, the second timing signal is always “0”, i.e., a timing signal not to change a light source luminance. By comparing a light source luminance of a previous frame with a light source luminance of a present frame, change or non-change of the light source luminance is selected. In the first embodiment, by setting the second timing signal to a second half of one frame period, a flicker occurred by change of the light source luminance is suppressed. However, in the fourth embodiment, by not changing the light source luminance, the flicker occurred by change of the light source luminance is suppressed. In comparison with the first embodiment, component of the second timing signal generation unit is simplified, and a circuit scale can be reduced. Hereinafter, the light source control unit 120 having different component from the first embodiment is explained in detail.

(The Light Source Control Unit 120)

In the first embodiment, a first timing signal and a second timing signal are generated based on a synchronizing signal. However, in the fourth embodiment, the second timing signal is “0” irrespective of the synchronizing signal.

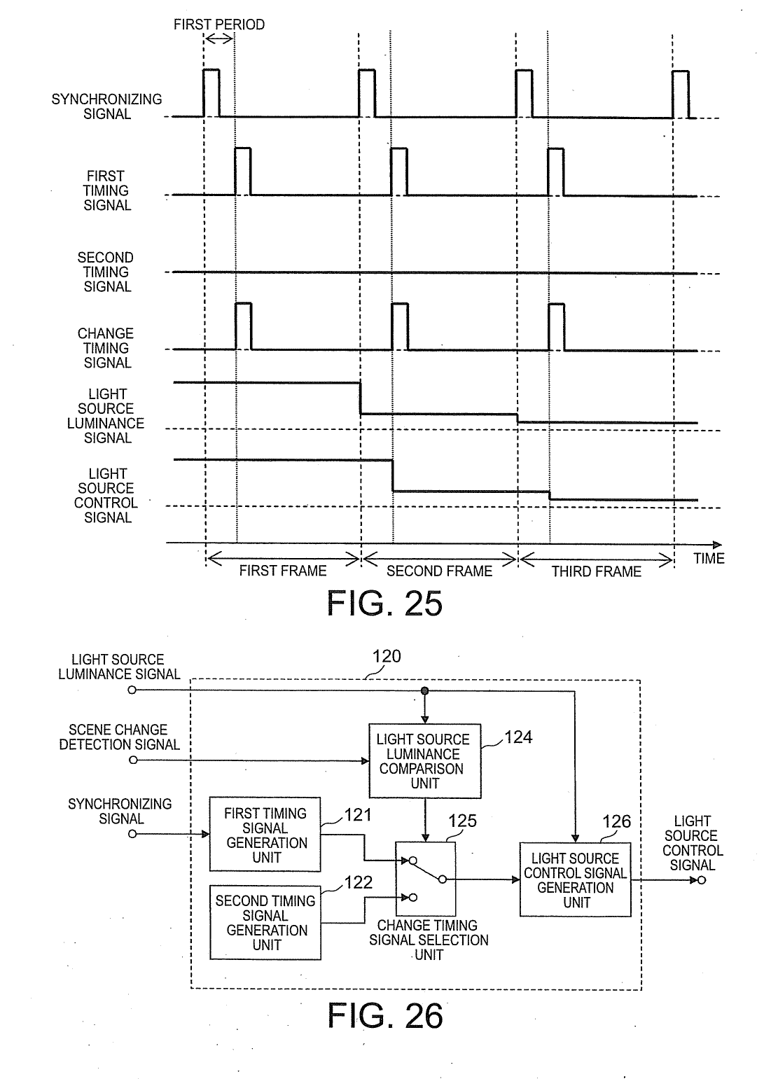

The light source control signal is explained by referring to FIGS. 24 and 25. As shown in FIGS. 24 and 25, the first timing signal is a signal to output when a first period has passed from the synchronizing signal, and the second timing signal is always “0” signal. Based on a selection signal from the light soured luminance comparison unit 124, the change timing signal selection unit 125 selects any of the first and second timing signals. By comparing a light source luminance of a previous frame and a light source luminance of a present frame, the light source luminance comparison unit 124 outputs the selection signal. In the fourth embodiment, the selection signal is output by an equation (7).

$$selection signal = \{ \begin{matrix}first timing signal I ( n ) - I ( n - 1 ) ≺ T \\ second timing signal I ( n ) - I ( n - 1 ) \geq T\end{matrix} \qquad ( 7 )$$

In the equation (7), “I(n)” represents a light source luminance of the n-th frame, and “T” represents a threshold. A light source luminance of the previous frame is subtracted from a light source luminance of the present frame. If the difference is equal to or larger than the threshold T, the second timing signal is selected. In another case, the first timing signal is selected. For example, as shown in FIG. 24, the light source luminance changes larger than T between the first frame and the second frame, and the second timing signal is selected as a change timing signal. As a result, the change timing signal is “0” signal (the light source control signal does not change), and a light source luminance calculated from the first frame does not change in the second frame. On the other hand, the light source luminance changes smaller than T between the second frame and the third frame, and the first timing signal is selected as a change timing signal. As a result, the light source control signal changes at the first timing. Furthermore, as shown in FIG. 25, if the light source luminance changes smaller than T between the first frame and the second frame, and if the light source luminance changes smaller than T between the second frame and the third frame, the light source control signal changes at the first timing in the first, second and third frames.

As mentioned-above, in the fourth embodiment, the flicker occurred by change of the light source luminance can be suppressed. As a result, the image display apparatus having an excellent visual contrast is provided with the reduced power consumption.

### The Fifth Embodiment

Basis component of the image display apparatus of the fifth embodiment is same as the fourth embodiment. By preparing the scene change detection unit 140, a timing to change a light source luminance is controlled based on a change of the light source luminance and a detection result of scene change. Hereinafter, the light source control unit 140 having different component from the fourth embodiment is explained in detail.

(The Light Source Control Unit 120)

A scene change detection signal is input to the light source luminance comparison unit 124. Based on the scene change detection signal, and light source luminance signals of a previous frame and a present frame, the light source luminance comparison unit 124 generates a selection.

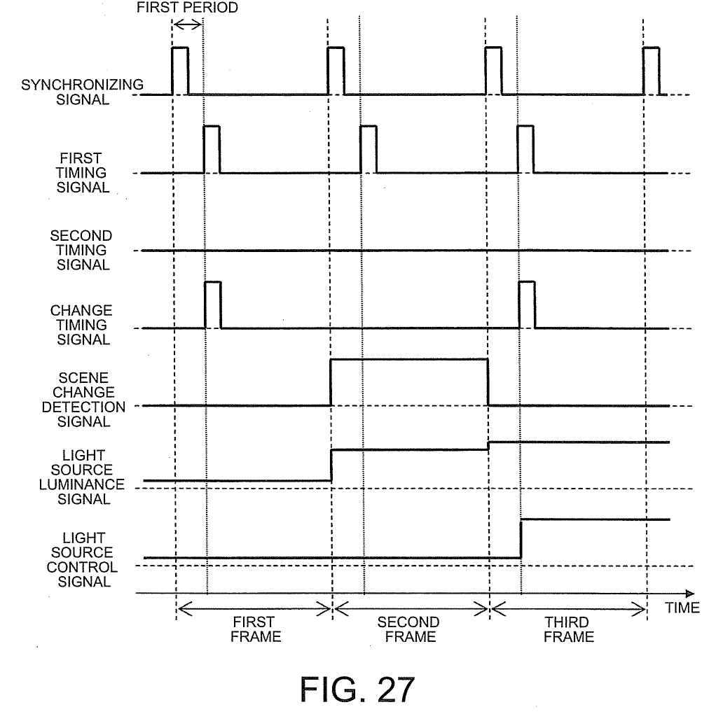

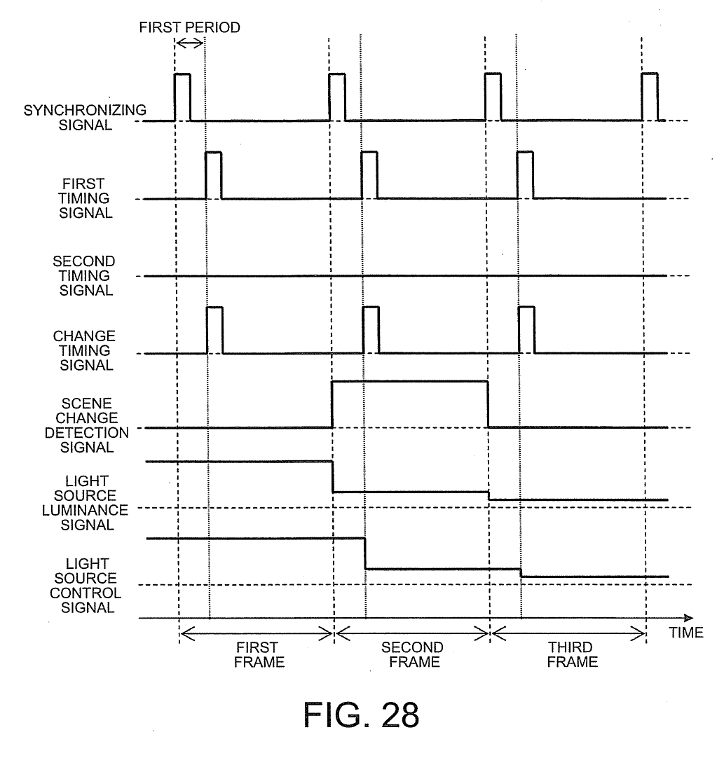

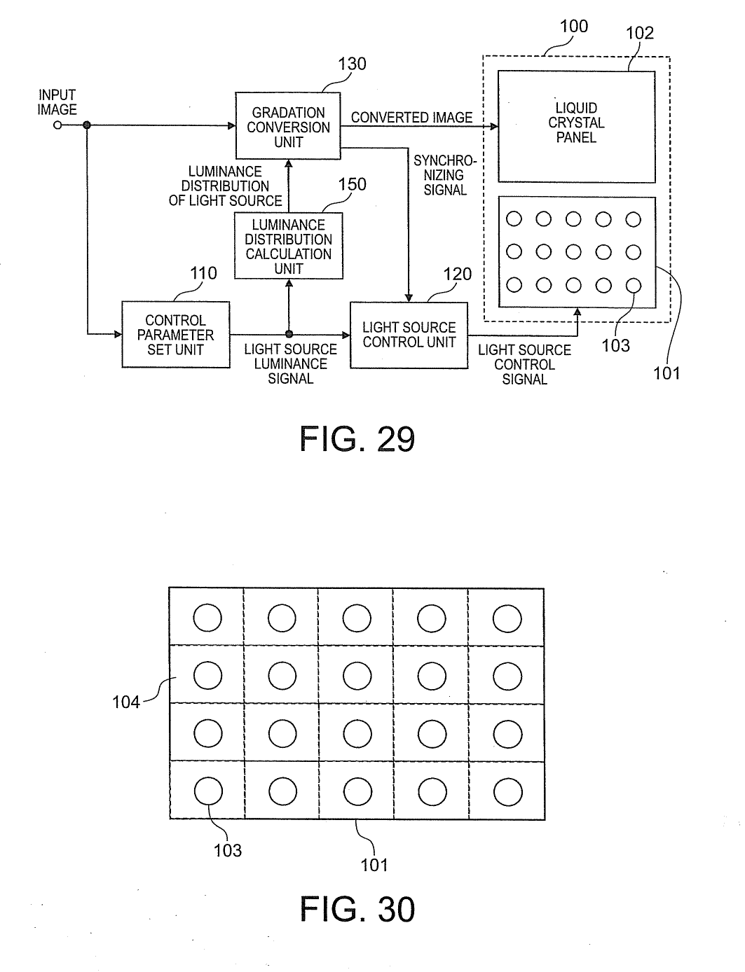

Change timing of the light source control signal is explained by referring to FIGS. 27 and 28. As shown in FIGS. 27 and 28, the first timing signal is a signal to output when a first period has passed from the synchronizing signal, and the second timing signal is always “0” signal. Based on a selection signal from the light source luminance comparison unit 124, the change timing signal selection unit 125 selects any of the first and second timing signals. By comparing a light source luminance of a previous frame and a light source luminance of a present frame, the light source luminance comparison unit 124 outputs the selection signal based on a scene change detection signal and the comparison result. In the fourth embodiment, the selection signal is output by an equation (7).

$$selection signal = \{ \begin{matrix}first timing signal [ s ( n ) = 0 ] ⋁ [ I ( n ) - I ( n - 1 ) ≺ T ] \\ second timing signal [ s ( n ) = 1 ] ⋀ [ I ( n ) - I ( n - 1 ) \geq T ]\end{matrix} \qquad ( 8 )$$

In the equation (8), “I(n)” represents a light source luminance of the n-th frame, and “s(n)” represents a scene change detection signal of the n-th frame. A light source luminance of the previous frame is subtracted from a light source luminance of the present frame. If scene change is detected and the difference is equal to or larger than “0”, the second timing signal is selected. In another case, the first timing signal is selected. For example, as shown in FIG. 27, if scene change is detected and the light source luminance changes larger than “0” between the first frame and the second frame, the second timing signal is selected as a change timing signal. As a result, the change timing signal is “0” signal (the light source control signal does not change), and a light source luminance calculated from the first frame does not change in the second frame. On the other hand, the light source luminance changes larger than “0” between the second frame and the third frame. However, scene change is not detected between the second frame and the third frame. Accordingly, the first timing signal is selected as a change timing signal. As a result, the light source control signal changes at the first timing. Furthermore, as shown in FIG. 28, if the light source luminance changes smaller than “0” between the first frame and the second frame, and if the light source luminance changes smaller than “0” between the second frame and the third frame, the light source control signal changes at the first timing in the first, second and third frames.

### The Sixth Embodiment

As to the image display apparatus of the sixth embodiment, a plurality of light sources is set on the backlight 101, and a light source luminance of each light source 103 can be controlled. The image display apparatus includes the image display unit 100, the control parameter set unit 110, the light source control unit 120, the gradation conversion unit 130, and a luminance distribution calculation unit 150. The image display unit 100 includes the liquid crystal panel 102 as a light modulator and the backlight 101 (set at the back of the liquid crystal panel 102) having a plurality of light sources 103.

An image is input to the control parameter set unit 110 and the gradation conversion unit 130. The control parameter set unit 110 calculates a luminance of each light source 103 on the backlight 101 for each region of the image corresponding to each light source 103. This luminance is input as a light source luminance signal to the luminance distribution calculation unit 150 and the light source control unit 120. The luminance distribution calculation unit 150 calculates a luminance distribution of the backlight 101 using a luminance distribution of each light source 103 of the backlight 101, in case that the plurality of light sources 103 lightens based on a light source luminance signal. The luminance distribution of the backlight 101 is input to the gradation conversion unit 130. The gradation conversion unit 130 converts a gradation of each pixel of the input image based on the luminance distribution, and outputs a converted image having a converted gradation of each pixel. Furthermore, the gradation conversion unit 130 outputs a synchronizing signal (synthesized with output timing of the converted image) to the light source control unit 120. The light source control unit 120 outputs a light source control signal (based on light source luminance signals of the plurality of light sources 130) to the backlight 101 at a timing based on the synchronizing signal. In the image display unit 100, the converted image is written onto the liquid crystal panel 102. Furthermore, by lightening the plurality of light sources of the backlight 101 based on the light source control signal, the converted image is displayed on the image display unit 100. Hereinafter, processing of each unit is explained.

(The Control Parameter Set Unit 110)

The control parameter set unit 110 calculates a light source luminance of each light source 103 of the backlight 101, and outputs as a light source luminance signal. In the first embodiment, the light source luminance is set using a maximum from the entire input image. However, in the sixth embodiment, a maximum is determined for each region of the input image in correspondence with each light source 103 of the backlight 101. For example, as shown in FIG. 30, the backlight structure has five light sources along a horizontal direction and four light sources along a vertical direction. In this case, the input image is divided into 5×4 regions corresponding to each light source, and a light source of each region 104 is calculated based on a maximum calculated from each region 104. In the sixth embodiment, one light source 103 corresponds with one divided region 104. However, for example, a plurality of light sources 103 may correspond with one divided region 104. Furthermore, in FIG. 30, the input image is equally divided into each region 104 by the number of light sources. However, by dividing the input image so that a plurality of regions 104 partially overlaps, a maximum of each region may be calculated. The light source control signal of each light source 103 is input to the luminance distribution calculation unit 150 and the light source control unit 120.

(The Luminance Distribution Calculation Unit 150)

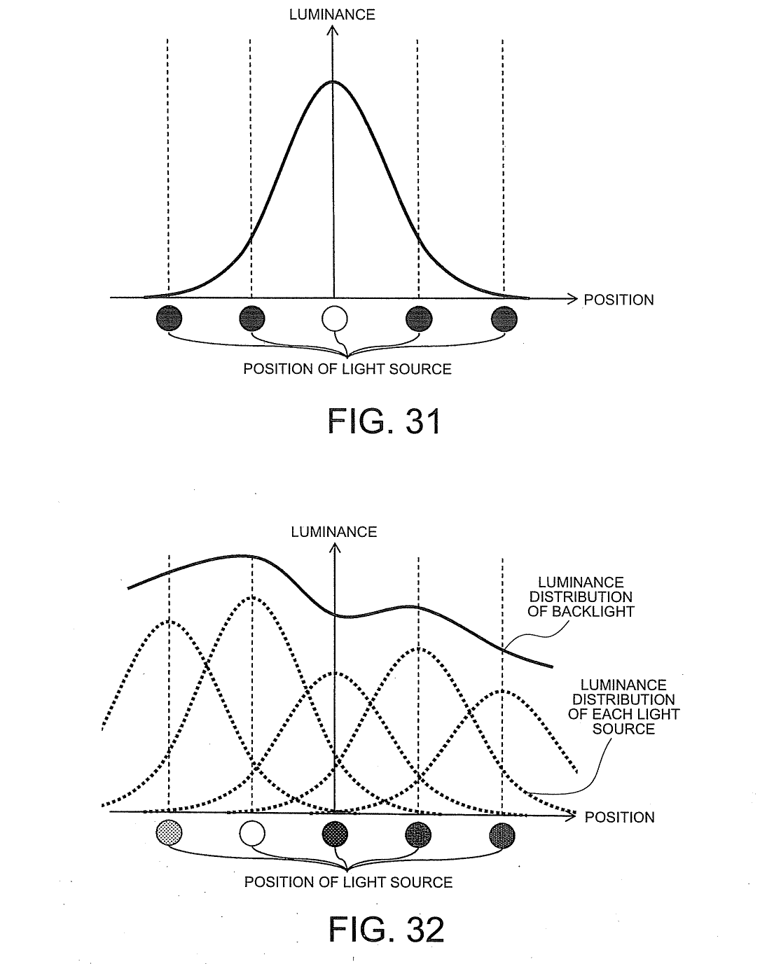

The luminance distribution calculation unit 150 calculates a luminance distribution of the backlight 101 based on a light source luminance signal of each light source. FIG. 31 shows a luminance distribution of one of the plurality of light sources 103 on the backlight 101. In order to simplify the explanation, the luminance distribution is represented by one-dimension, a horizontal axis represents a position, and a vertical axis represents a luminance. Each light source 103 is set at a position of lower part in FIG. 31, and a luminance distribution of one light source at a center position (white circle) is shown in case that the one light source only lightens. As shown in FIG. 31, a luminance distribution of one light source 103 spreads over positions of adjacent light sources. In order for the gradation conversion unit 130 to convert a gradation based on light source luminance, by adding a luminance distribution of each light source of the backlight 101 in FIG. 31, a luminance distribution of the backlight 101 is actually calculated.

FIG. 32 shows a luminance distribution of the backlight 101 in case that the plurality of light sources 103 lightens. In order to simplify the explanation, this luminance distribution is represented by one-dimension. When a plurality of light sources at a position of a lower part of FIG. 32 respectively lightens, each light source has a luminance distribution as shown in dotted lines of FIG. 32. By adding luminance distributions of each light source, a luminance distribution of the backlight 101 is calculated as a solid line of FIG. 32.

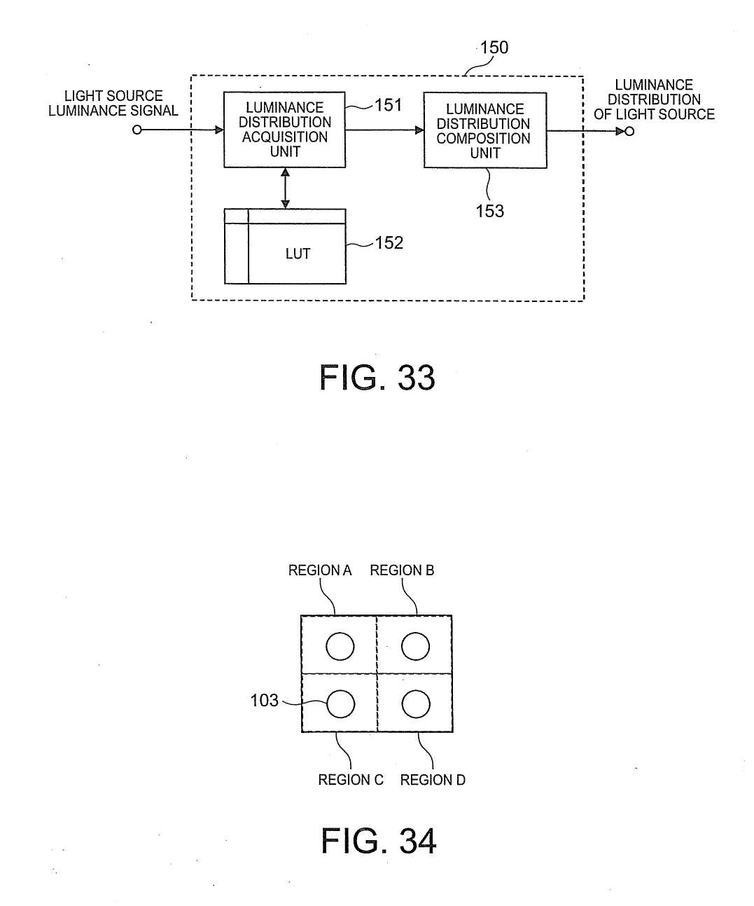

As to a luminance distribution of each light source luminance 103 in FIG. 31, an actual value (measured value) is approximated as a function related with a distance from the light source 103, and the function is stored in the luminance distribution calculation unit 150. In the sixth embodiment, a relationship between a luminance and a distance from the light source is calculated and stored in LUT 152 (ROM). FIG. 33 is a block diagram of the luminance distribution calculation unit 150. In FIG. 33, light source luminance calculated for each light source 103 is input to a luminance distribution acquisition unit 151 as a light source luminance signal. The luminance distribution acquisition unit 151 acquires a luminance distribution of each light source 103 from LUT 152, and multiplies a light source luminance signal (calculated by the control parameter set unit 110 as a backlight luminance) with the luminance distribution of each light source. As a result, an actual luminance distribution of each light source 103 is calculated as shown in dotted lines in FIG. 32. Next, a luminance distribution composition unit 150 adds the actual luminance distribution of each light source 103. As a result, a luminance distribution of the backlight 101 is calculated as shown in a solid line of FIG. 32. The luminance distribution of the backlight 101 is input to the gradation conversion unit 130 as a luminance distribution of light source.

(The Gradation Conversion Unit 130)

The gradation conversion unit 130 converts a gradation value of each pixel of the input image based on the luminance distribution of light source. Basic component of the gradation conversion unit 130 is same as the first embodiment. However, a light source luminance is different for each position of the input image. Accordingly, the equation (3) is replaced with a following equation (9).

$${L}_{out} ( x , y ) = \frac{1}{{I ( x , y )}^{1 / γ}} {L}_{i n} ( x , y ) \qquad ( 9 )$$

In the equation (9), I(x,y) is a luminance (calculated by the luminance distribution calculation unit 150) of the backlight 101 at a position (x,y) of the input image. The gradation value may be converted directly using the equation (9). However, in the sixth embodiment, a LUT storing relationship among a gradation value Lᵢₙ of the input image, a light source luminance I, and a converted gradation value Lₒᵤₜ, is prepared. By referring to the LUT with a gradation value Lᵢₙ(x,y) of the input image and the luminance distribution I(x,y) of light source, the converted gradation value Lₒᵤₜ(x,y) is retrieved.

(The Light Source Control Unit 120)

The light source control unit generates a light source control signal to control a luminance of the backlight 101, based on the light source luminance signal of each light source 103 of the backlight. Furthermore, by changing a signal value of the light source control signal at timing based on the synchronizing signal, the light source luminance is controlled.

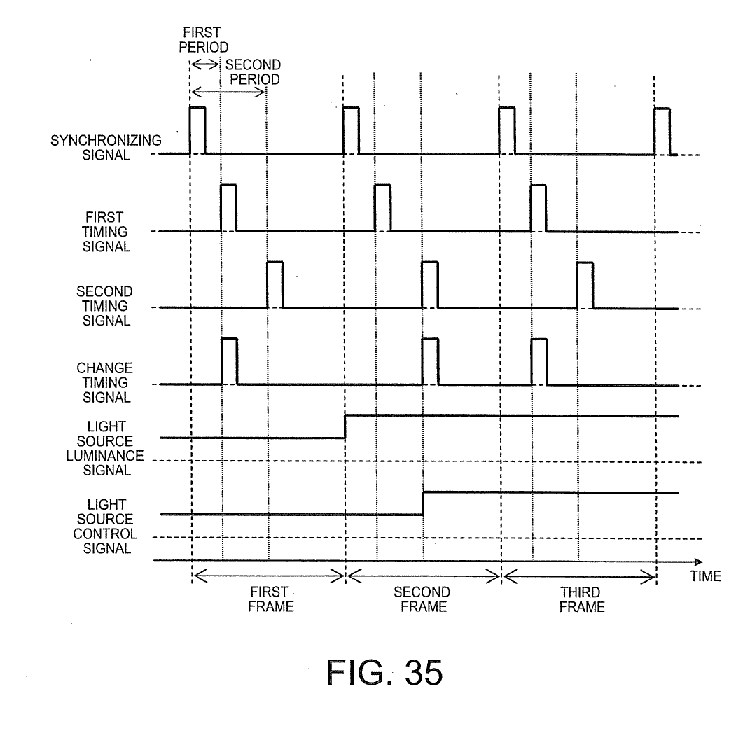

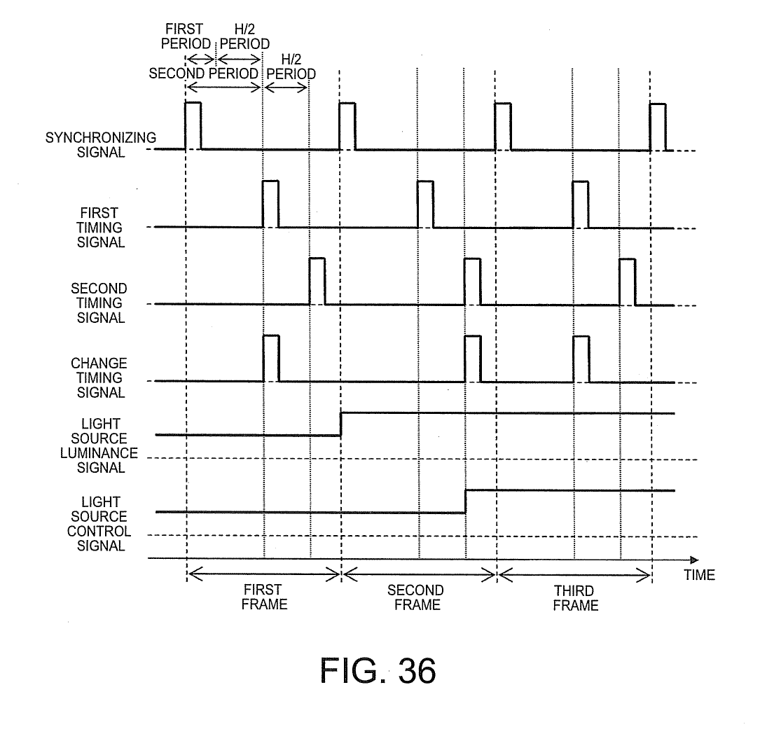

Basic component of the light source control unit 120 is same as the first embodiment. However, a plurality of light sources 103 is controlled in the sixth embodiment, while one light source is controlled in the first embodiment. In order to simplify the explanation, as shown in FIG. 34, the backlight 101 comprises four light sources 103 (two light sources along a horizontal direction and two light sources along a vertical direction), and the input image is divided into four regions (region A, region B, region C, region D) corresponding to each light source. In this case, change timing of the light source control signal is explained using FIGS. 35 and 36.

In FIGS. 35 and 36, a horizontal axis represents time, and a vertical axis represents a signal used by the light source control unit 120. FIG. 35 shows a change timing of the light source control signal of the light source 103 corresponding to regions A and B. FIG. 36 shows a change timing of the light source control signal of the light source 103 corresponding to regions C and D. A converted image is line-sequentially written onto the liquid crystal panel 102. Briefly, the converted image is written in order from the first line to the last line of the liquid crystal panel 102. Accordingly, regions A and B of the converted image are written in a half of one frame period.

As mentioned-above, regions A and B are regarded as the entire input image (in the first embodiment) limited to the regions A and B. As to the change timing of the light source control signal in FIG. 3 of the first embodiment, as shown in FIG. 35, the second period is shortened as H/2 (H: the number of vertical lines of the liquid crystal panel 102). Briefly, a first timing signal is same as that of the first embodiment, and a second timing signal is earlier as H/2 period than that of the first embodiment.

Next, as to regions C and D, the converted image starts to be written when H/2 period has approximately passed from the synchronizing signal. As shown in FIG. 36, a first timing signal and a second timing signal of regions C and D are respectively later as H/2 period than that of FIG. 35. Briefly, the first timing signal and the second timing signal are changed based on a position of each light source 103 of the backlight 101 along a vertical direction. In the same way as the first embodiment, based on a comparison result of light source luminance between a present frame and a previous frame, the first timing signal and the second timing signal are controlled for each light source 103. As a result, the same effect as the first embodiment can be acquired in the backlight 101 comprising a plurality of light sources 103.

(The Image Display Unit 100)

The image display unit 100 includes a liquid crystal panel 102 (a light modulator) and a backlight 101 (a light source). In the same way as the first embodiment, a light emitting diode (LED) having luminance easily controlled is used as a light source 103 of the backlight 101. The luminance of the LED is modulated by control of pulse width modulation (PWM). Accordingly, the light source control signal as a PWM signal based on the light source luminance of each light source 103 is input to the backlight 101. The image display unit 100 writes a converted image (converted by the gradation conversion unit 130) onto the liquid crystal panel 102. Furthermore, by lighting the backlight 101 based on the light source control signal of each light source (generated by the light source control unit 120), an image is displayed on the image display unit 100.

In above-mentioned embodiments, the liquid crystal display apparatus of transparent type having the liquid crystal panel 102 and the backlight 101 is explained. However, the present invention can be applied to various image display apparatuses except for the liquid crystal display apparatus. For example, as to an image display apparatus of projection type having the liquid crystal panel 102 (a light modulator) and a halogen light source, the present invention can be applied. Furthermore, as to another image display apparatus of projection type having the halogen light source and a digital micro mirror device (a light modulator) to control reflection of light from the halogen light source, the present invention can be applied.

Other embodiments of the invention will be apparent to those skilled in the art from consideration of the specification and embodiments of the invention disclosed herein. It is intended that the specification and embodiments be considered as exemplary only, with the scope and spirit of the invention being indicated by the claims.

What is claimed is:

1. An apparatus for displaying an image, comprising:
a light source configured to emit a light having a luminance;
a light source luminance decision unit configured to determine the luminance for a frame of the image, based on pixel values of the frame;
a conversion unit configured to convert each pixel value of the frame in correspondence with the luminance;
a light modulation unit configured to modulate a transmittance or a reflectance of the light based on each converted pixel value of the frame to display the image;
a selection unit configured to select a timing to change the luminance in a display period of the frame by comparing the luminance for the frame with a luminance for a previous frame; and
a control unit configured to change the luminance of the light source to the luminance for the frame at the timing.

2. The apparatus according to claim 1, wherein
the selection unit calculates a difference by subtracting the luminance for the previous frame from the luminance for the frame, selects a first timing that a first period has passed from a start timing to write the frame onto the light modulation unit if the difference is smaller than a first threshold, and selects a second timing that a second period longer than the first period has passed from the start timing if the difference is larger than the first threshold.

3. The apparatus according to claim 2, wherein
the first threshold is zero, and
the selection unit selects the first timing if the difference is positive value, and selects the second timing if the difference is negative value.

4. The apparatus according to claim 3, wherein
the selection unit sets the first timing for a next frame by delaying the second timing for the frame as one frame period.

5. The apparatus according to claim 3, wherein
the selection unit selects a third timing that a third period longer than the first period and shorter than the second period has passed from the start timing, if an absolute value of the difference is smaller than a second threshold.

6. The apparatus according to claim 2, wherein
the selection unit controls the timing to pass a longer period from the start timing if the difference is larger.

7. The apparatus according to claim 1, further comprising:
a detection unit configured to detect a scene change between the frame and the previous frame, based on pixel values of the frame and pixel values of the previous frame;
wherein the selection unit selects the timing based on a difference between the luminance for the frame and the luminance for the previous frame, if the detection unit detects the scene change.

8. The apparatus according to claim 2, further comprising:
a detection unit configured to detect a scene change between the frame and the previous frame, based on pixel values of the frame and pixel values of the previous frame;
wherein the selection unit selects the first timing or the second timing based on the difference if the detection unit detects the scene change, and selects a third timing within a period between the first timing and the second timing if the detection unit does not detect the scene change.

9. The apparatus according to claim 2, further comprising:
a detection unit configured to detect a scene change between the frame and the previous frame, based on pixel values of the frame and pixel values of the previous frame;
wherein the selection unit selects the first timing or the second timing based on the difference if the detection unit detects the scene change, and selects a third timing within a period between the first timing and the second timing if the detection unit does not detect the scene change.

10. The apparatus according to claim 7, wherein
the selection unit selects the second timing, if the detection unit detects the scene change and if the difference is larger than a second threshold.

11. An apparatus for displaying an image, comprising:
a plurality of light sources configured to respectively emit a light having a luminance, each light source being set in correspondence with each region on a frame of the image;
a light source luminance decision unit configured to determine the luminance of a light source, based on pixel values of a region corresponding to the light source;
a conversion unit configured to convert each pixel value of the region in correspondence with the luminance of the light source;
a light modulation unit configured to modulate a transmittance or a reflectance of the light from the light source, based on each converted pixel value of the region;
a selection unit configured to select a timing to change the luminance in a display period of the region by comparing the luminance for the region with a luminance for a corresponding region on a previous frame; and
a control unit configured to change the luminance of the light source to the luminance for the region at the timing.

12. A method for displaying an image, comprising:
determining a luminance of a light source based on pixel values of a frame of the image;
converting each pixel value of the frame in correspondence with the luminance;
modulating a transmittance or a reflectance of a light from the light source, based on each converted pixel value of the frame;
selecting a timing to change the luminance in a display period of the frame by comparing the luminance for the frame with a luminance for a previous frame; and
changing the luminance of the light source to the luminance for the frame at the timing.
